(19) United States
(12) Patent Application Publication
(10) Pub. No.: US 2026/0113782 A1
(43) Pub. Date: Apr. 23, 2026

(54) RANDOM ACCESS CONFIGURATION FOR SUBBAND FULL-DUPLEX

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US)

(21) Appl. No.: 18/921,942

(22) Filed: Oct. 21, 2024

(51) Int. Cl. H04W 74/0833; H04W 74/00

(52) U.S. Cl. CPC H04W 74/0833; H04W 74/004

(57) ABSTRACT

In some implementations, a user equipment (UE) may receive, from a network node, a random access configuration including at least one partition of random access channel (RACH) resources, wherein the at least one partition includes a partition for subband full duplex (SBFD) operation, and wherein the partition for SBFD operation is associated with repetitions. The UE may transmit, in accordance with the random access configuration, one or more repetitions of multiple repetitions of a random access message using one or more RACH resources as indicated by the partition for SBFD operation.

### FIELD OF THE DISCLOSURE

Aspects of the present disclosure generally relate to wireless communication and specifically relate to techniques, apparatuses, and methods associated with a random access configuration for subband full-duplex operation.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, an apparatus configured for wireless communication includes one or more memories comprising processor-executable instructions; and one or more processors configured to execute the processor-executable instructions and cause the apparatus to: receive, from a network node, a random access configuration including at least one partition of random access channel (RACH) resources, wherein the at least one partition includes a partition for subband full duplex (SBFD) operation, and wherein the partition for SBFD operation is associated with repetitions; and transmit, in accordance with the random access configuration, one or more repetitions of multiple repetitions of a random access message using one or more RACH resources as indicated by the partition for SBFD operation.

In some aspects, a method of wireless communication performed by a user equipment (UE) includes receiving, from a network node, a random access configuration including at least one partition of RACH resources, wherein the at least one partition includes a partition for SBFD operation, and wherein the partition for SBFD operation is associated with repetitions; and transmitting, in accordance with the random access configuration, one or more repetitions of multiple repetitions of a random access message using one or more RACH resources as indicated by the partition for SBFD operation.

In some aspects, a non-transitory computer-readable medium storing a set of instructions for wireless communication includes one or more instructions that, when executed by one or more processors of a UE, cause the UE to: receive, from a network node, a random access configuration including at least one partition of RACH resources, wherein the at least one partition includes a partition for SBFD operation, and wherein the partition for SBFD operation is associated with repetitions; and transmit, in accordance with the random access configuration, one or more repetitions of multiple repetitions of a random access message using one or more RACH resources as indicated by the partition for SBFD operation.

In some aspects, an apparatus for wireless communication includes means for receiving, from a network node, a random access configuration including at least one partition of RACH resources, wherein the at least one partition includes a partition for SBFD operation, and wherein the partition for SBFD operation is associated with repetitions; and means for transmitting, in accordance with the random access configuration, one or more repetitions of multiple repetitions of a random access message using one or more RACH resources as indicated by the partition for SBFD operation.

In some aspects, an apparatus configured for wireless communication includes one or more memories comprising processor-executable instructions; and one or more processors configured to execute the processor-executable instructions and cause the apparatus to: transmit a random access configuration including at least one partition of RACH resources, wherein the at least one partition includes a partition for SBFD operation, and wherein the partition for SBFD operation is associated with repetitions; and receive, in accordance with the random access configuration, one or more repetitions of multiple repetitions of a random access message, associated with a UE, using one or more RACH resources as indicated by the partition for SBFD operation.

In some aspects, a method of wireless communication performed by a network node includes transmitting a random access configuration including at least one partition of RACH resources, wherein the at least one partition includes a partition for SBFD operation, and wherein the partition for SBFD operation is associated with repetitions; and receiving, in accordance with the random access configuration, one or more repetitions of multiple repetitions of a random access message, associated with a UE, using one or more RACH resources as indicated by the partition for SBFD operation.

In some aspects, a non-transitory computer-readable medium storing a set of instructions for wireless communication includes one or more instructions that, when executed by one or more processors of a network node, cause the network node to: transmit a random access configuration including at least one partition of RACH resources, wherein the at least one partition includes a partition for SBFD operation, and wherein the partition for SBFD operation is associated with repetitions; and receive, in accordance with the random access configuration, one or more repetitions of multiple repetitions of a random access message, associated with a UE, using one or more RACH resources as indicated by the partition for SBFD operation.

In some aspects, an apparatus for wireless communication includes means for transmitting a random access configuration including at least one partition of RACH resources, wherein the at least one partition includes a partition for SBFD operation, and wherein the partition for SBFD operation is associated with repetitions; and means for receiving, in accordance with the random access configuration, one or more repetitions of multiple repetitions of a random access message, associated with a second apparatus, using one or more RACH resources as indicated by the partition for SBFD operation.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of selection of a number of repetitions for transmitting a random access message, in accordance with the present disclosure.

FIGS. 4A-4C are diagrams illustrating examples of full-duplex communication, in accordance with the present disclosure.

FIG. 5 is a diagram illustrating examples of full-duplex communication in a wireless network, in accordance with the present disclosure.

FIG. 6 is a diagram illustrating an example of a subband full-duplex (SBFD) structure, in accordance with the present disclosure.

FIG. 7 is a diagram illustrating an example of random access channel (RACH) occasion groups, in accordance with the present disclosure.

FIG. 8 is a diagram illustrating an example of RACH occasions within SBFD time intervals, in accordance with the present disclosure.

FIG. 9 is a diagram illustrating an example associated with a random access configuration for SBFD, in accordance with the present disclosure.

FIG. 10 is a diagram illustrating an example associated with a random access configuration for SBFD, in accordance with the present disclosure.

FIG. 11 is a diagram illustrating an example associated with a random access configuration for SBFD, in accordance with the present disclosure.

FIG. 12 is a flowchart of an example method of wireless communication.

FIG. 13 is a flowchart of an example method of wireless communication.

FIG. 14 is a diagram of an example apparatus for wireless communication, in accordance with the present disclosure.

FIG. 15 is a diagram of an example apparatus for wireless communication, in accordance with the present disclosure.

FIG. 16 is a diagram illustrating an example of an implementation of code and circuitry for a communications device, in accordance with the present disclosure.

FIG. 17 is a diagram illustrating an example of an implementation of code and circuitry for a communications device, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a user equipment (UE) may perform a random access procedure (e.g., a random access channel (RACH) procedure) with a network node to enable the UE to establish a connection with the network node, such as for an initial access, a link recovery, and/or a beam failure recovery, among other examples. The RACH procedure may include the exchange of one or more random access messages between the UE and the network node. For example, the UE may transmit a preamble, such as physical RACH (PRACH) preamble. In some examples, the UE may utilize resources that are configured (such as via system information signaling) for initiating random access procedures with the network node.

To enhance uplink coverage and address issues associated with weak signal conditions, the UE may transmit repetitions of one or more random access messages during a RACH procedure. As used herein, “repetition” may refer to an initial transmission of a message and also to a repeated transmission of the message. Thus, each transmission (regardless of whether the transmission is an initial transmission or a retransmission) may be referred to as a repetition. For example, the UE may transmit multiple instances of a random access message (e.g., of a PRACH preamble) in one or more time intervals. This repetition increases the likelihood that at least one transmission of the random access message will be successfully received by the network node, thereby improving the robustness and/or reliability of the random access message. The network node may combine multiple transmissions (e.g., repetitions) of the random access message to improve the reliability of the random access message, such as for a UE located at an edge of a cell coverage area associated with the network node.

To enable repetitions of a random access message (e.g., to enable the network node to reliably identify and/or combine repetitions of a random access message), RACH occasions (ROs) may be organized into RO groups. As used herein, “occasion” refers to one or more resources (e.g., time domain resources, frequency domain resources, spatial domain resources, code domain resources, and/or other resources) that are available for, or configured for, the communication (e.g., the transmission and/or the reception) of a communication or message (e.g., an RO may be one or more resources available for, or configured for, the communication of a random access message). An RO group may include multiple ROs. “RO group” may be used interchangeably with “set of ROs” herein. The configuration or organization of RO groups may enable the network node to identify and/or combine repetitions of a random access message. For example, if a UE is configured to transmit repetitions of a random access message, then the UE may transmit the repetitions during respective ROs included in a given RO group. This enables the network node to identify the ROs in which the repetition of the random access message are to be transmitted. This organization enables the network node to correctly and/or reliably detect, identify, and/or combine the multiple repetitions of the random access message for efficient signal processing and accurate detection.

The management of RACH configurations and repetitions enables efficient network performance and robust uplink coverage. The introduction of subband full duplex (SBFD) frameworks within a time division duplex (TDD) carrier introduces complexities for RO configurations and/or for forming RO groups for repetitions of a random access message. For example, UEs that support an SBFD capability (e.g., referred to herein as “SBFD-aware” UEs) may consider or identify that ROs that occur in an uplink subband of an SBFD time interval are valid (e.g., are available to be used). UEs that do not support the SBFD capability (e.g., referred to herein as “non-SBFD-aware” UEs or “legacy” UEs) may consider or identify that ROs that occur in an uplink subband of an SBFD time interval are invalid because these UEs may not be configured to transmit uplink signals during the SBFD time interval (e.g., because these UEs may consider SBFD time intervals to be downlink time intervals).

For example, a network node may configure ROs that align both spatially and temporally to ensure that repetitions of a random access message (e.g., of PRACH preambles) are correctly received and processed. Different UEs may transmit various numbers of repetitions based on conditions experienced by the UEs, such as individual received signal levels. In some examples, random access resources (e.g., ROs and/or preamble indices) for a given number of repetitions may be indicated and/or configured via a partition of random access resources (e.g., as indicated by a featureCombinationPreamble parameter).

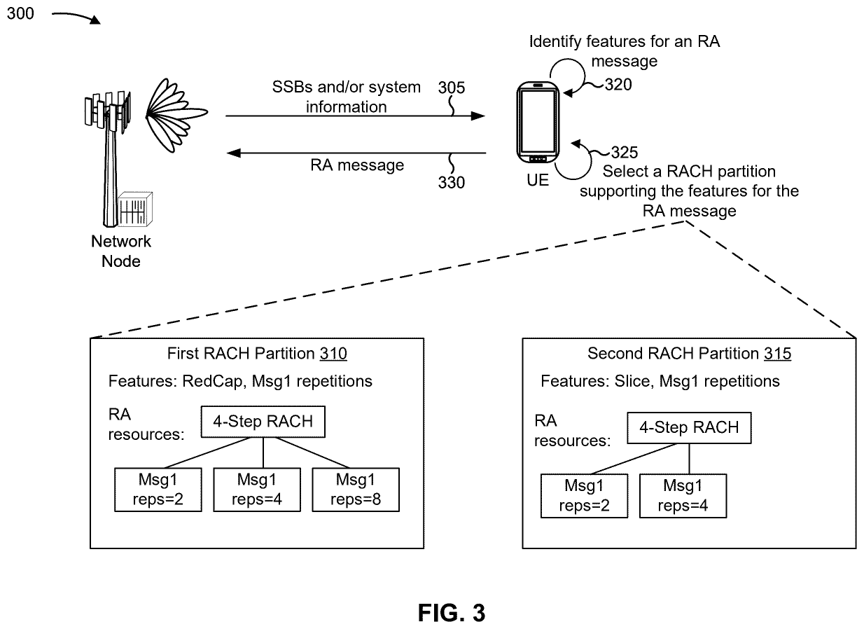

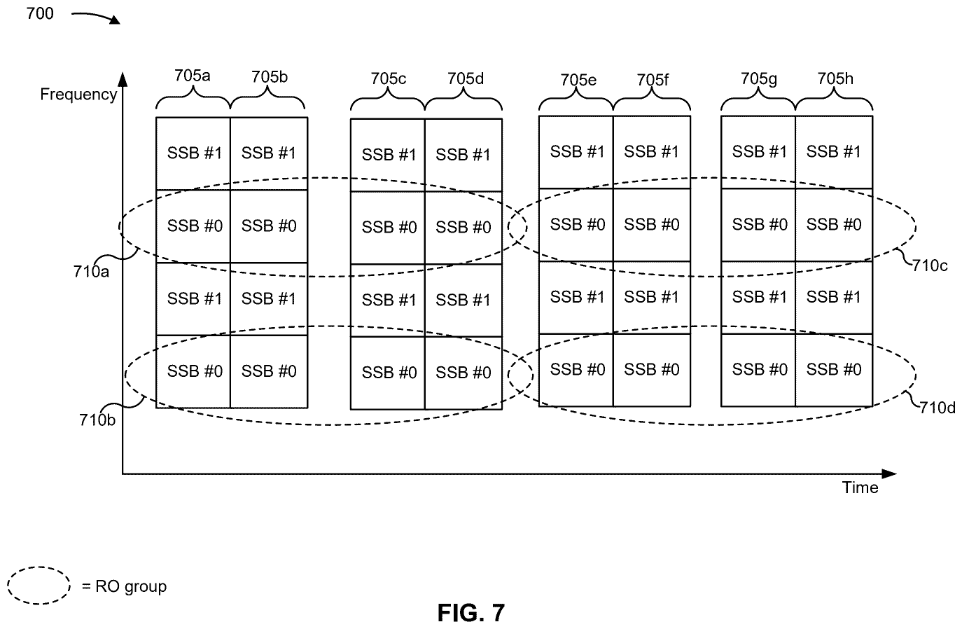

However, having ROs that are valid for some UEs and not for other UEs increases the complexity associated with forming RO groups, such as for repetitions of a preamble in a PRACH transmission (e.g., as described in more detail elsewhere herein, such as in connection with FIG. 7). For example, as described elsewhere herein, random access resources for different repetition numbers may be configured via separate partitions of random access resources (e.g., as described in more detail elsewhere herein, such as in connection with FIG. 3). Random access resources of a partition that are configured via the same feature combination parameter may be considered to be within the same set of random access resources. Therefore, if a partition defines or indicates random access resources available to be used for a given number of repetitions of a random access message (e.g., of a preamble), it is expected that the random access resources are from the same set of random access resources for all UEs. This may result in a misalignment of formed RO groups among different UEs and/or between a UE and a network node because different UEs may consider a given RO valid, whereas other UEs may consider the given RO invalid (e.g., SBFD-aware UEs may consider an RO in an uplink subband to be valid, whereas a legacy UE may consider the same RO to be invalid). The misalignment of formed RO groups may result in inefficient and/or degraded processing of repetitions of a random access message by the network node (e.g., because the network node may identify an RO group as including a first one or more ROs and the UE may identify the RO group as including a second one or more ROs). Alternatively, to address the potential misalignment, the set of random access resources for the partition may not include random access resources (e.g., ROs) configured to occur within SBFD time intervals. This may result in increased latency and/or inefficient resource utilization for SBFD-aware UEs because there may be ROs that could have otherwise been used for transmission by the SBFD-aware UEs, but that are not included in the set of random access resources for the partition.

Therefore, the process of providing ROs, such as those suitable for SBFD-aware UEs, is complex. There lacks a clear model for integrating SBFD considerations into the existing hierarchy of RACH configurations, such as for repetitions of random access messages. For example, difficulties arise in defining and managing sets of ROs (e.g., RO groups) that are consistent and efficient for UEs with differing duplexing capabilities. The integration of SBFD into RACH configurations poses challenges in forming RO groups and ensuring that UEs with different capabilities can correctly interpret system information to access the network effectively and/or to ensure that a network node can correctly and/or efficiently process repetitions of a random access message from a given UE.

Various aspects relate generally to a random access configuration for SBFD operation. Some aspects more specifically relate to a network node transmitting, and a UE receiving, a random access configuration that includes at least one partition of RACH resources. The partition includes (or indicates) random access resources for SBFD operation associated with repetitions. The UE may transmit, and the network node may receive, one or more repetitions of a random access message using RACH resources indicated by the partition for SBFD operation.

Particular aspects of the subject matter described in this disclosure can be implemented to realize one or more of the following potential advantages. In some examples, the described techniques can be used to improve the synchronization and/or resource utilization efficiency of random access resources for repetitions by SBFD-aware UEs. For example, by the network node configuring a partition of random access resources for SBFD operation and repetitions, the set of random access resources included in the partition can include ROs that occur during SBFD time intervals. This improves uplink coverage, reduces latency, and/or improves resource utilization efficiency because SBFD-aware UEs can use the ROs that occur during SBFD time intervals. Additionally, by the network node configuring separate partition(s) for SBFD operation, the number of available ROs that can be configured for different features for random access messages (e.g., repetitions, slice support, reduced capability (RedCap) support, and/or other features) may be increased (e.g., because the set of random access resources for the partition(s) is not limited to random access resources that are valid for non-SBFD-aware UEs).

In some aspects, the UE may select one or more RACH resources from a partition associated with a capability of the UE, such as an SBFD capability. For example, the random access configuration may include different partitions for SBFD and non-SBFD operations. The UE may identify and/or select the partition and associated RACH resources based on one or more capabilities of the UE, including whether the UE is an SBFD-aware UE or a non-SBFD aware UE. For example, the UE may select one or more random access resources from the partition for SBFD operation. By the UE transmitting the one or more repetitions of the random access message using the random access resources from the partition for SBFD operation, the network node may identify that the UE is an SBFD-aware UE.

In some aspects, by the UE receiving one or more RACH configurations with partitions tailored for SBFD capabilities and transmitting repetitions accordingly, the UE can make more efficient use of random access resources, thereby enabling improved resource utilization efficiency. By the network node configuring distinct partitions for respective duplexing capabilities, the network node may effectively allocate and manage RACH resources tailored to the capabilities and requirements of diverse UEs configured to operate in a coverage area (e.g., a cell) supported by the network node. For example, a first partition for SBFD operation may facilitate operation of UEs that are capable of identifying SBFD time intervals. A second partition (e.g., for non-SBFD operation) may ensure that UEs operating under legacy duplexing modes or other non-SBFD modalities also have access to properly allocated RACH resources.

By the network node configuring the partition for SBFD operation, the network node may improve the likelihood of RO groups being synchronized between the UEs and the network node. The synchronization facilitates a seamless and coherent communication process, thereby reducing the likelihood of the network node incorrectly processing the multiple repetitions of the random access message transmitted by the UE. For example, by configuring the partition for SBFD operation, the UE and the network node may be synchronized as to the random access resources available for repetitions of a random access message by an SBFD-aware UE. By ensuring that both UEs and the network node have a consistent understanding and alignment of the RO groups, the system can achieve more efficient and accurate random access procedures. This alignment optimizes the use of available RACH resources, leading to improved network capacity and throughput. Furthermore, the synchronization minimizes access delays and enhances the overall reliability of uplink transmissions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or RedCap device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

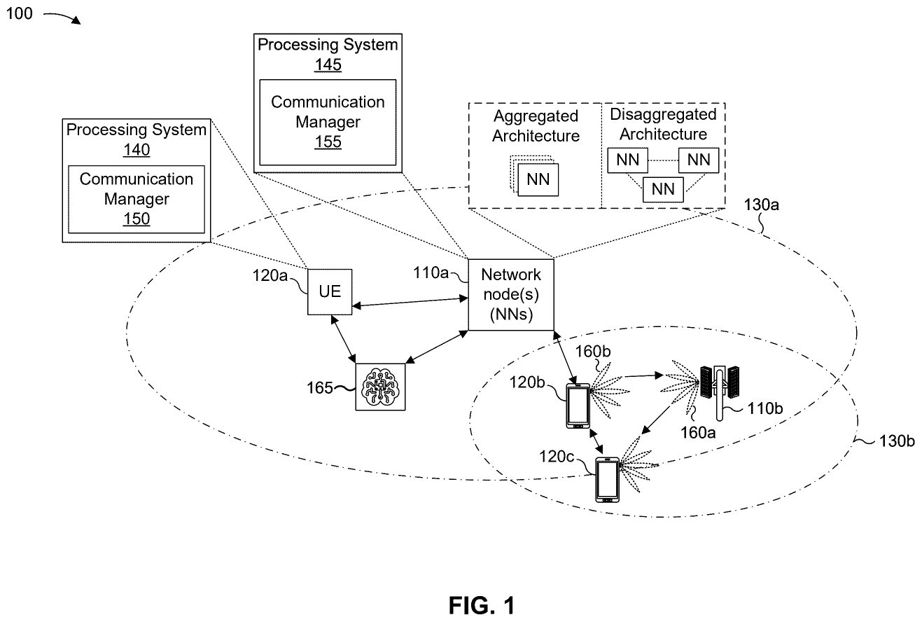

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHZ.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

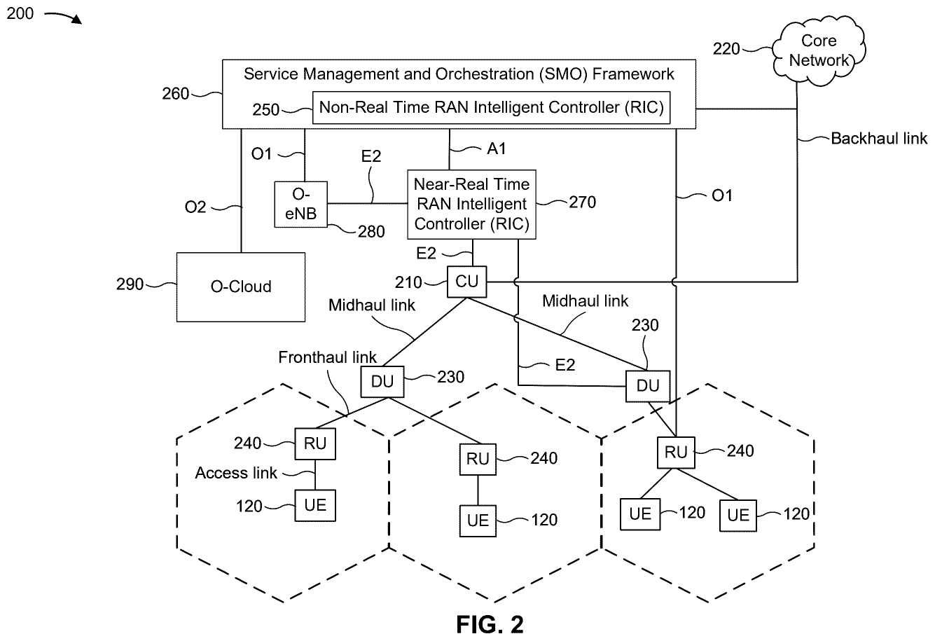

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 and/or UEs 120 may generally increase the capacity of the network and the radio access link. In some examples, full-duplex operation may involve frequency division duplexing, in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120, but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110, but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a network node, a random access configuration including at least one partition of RACH resources, wherein the at least one partition includes a partition for SBFD operation, and wherein the partition for SBFD operation is associated with repetitions; and transmit, in accordance with the random access configuration, one or more repetitions of multiple repetitions of a random access message using one or more RACH resources as indicated by the partition for SBFD operation. Additionally, or alternatively, the communication manager 150 may perform one or more other operations described herein.

In some aspects, the network node 110 may include a communication manager 155. As described in more detail elsewhere herein, the communication manager 155 may transmit a random access configuration including at least one partition of RACH resources, wherein the at least one partition includes a partition for SBFD operation, and wherein the partition for SBFD operation is associated with repetitions; and receive, in accordance with the random access configuration, one or more repetitions of multiple repetitions of a random access message, associated with a UE, using one or more RACH resources as indicated by the partition for SBFD operation. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

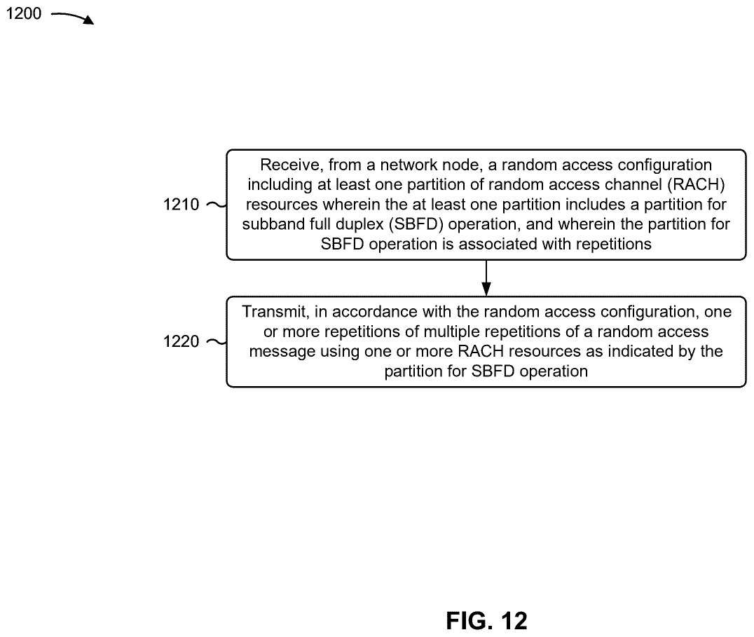

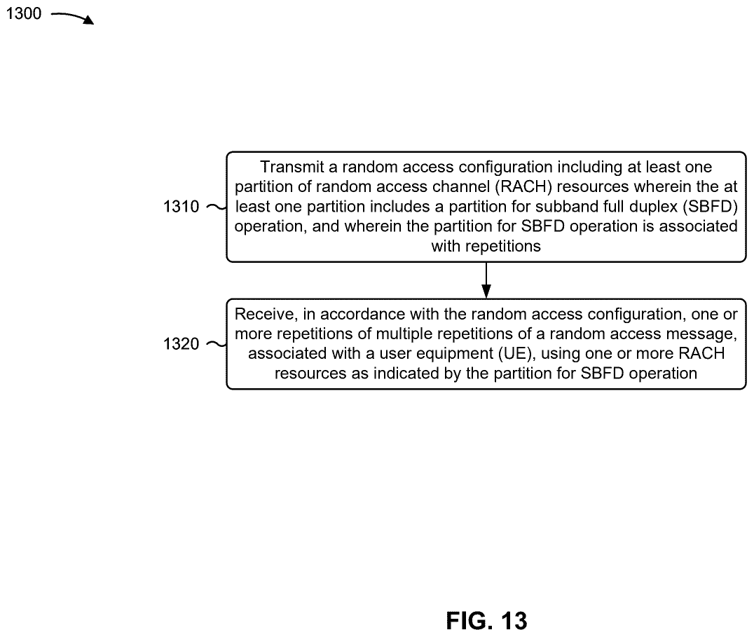

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a random access configuration for SBFD, as described in more detail elsewhere herein. For example, the processing system 145 of the network node 110, the processing system 140 of the UE 120, the CU 210, the DU 230, or the RU 240 may perform or direct operations of, for example, method 1200 of FIG. 12, method 1300 of FIG. 13, or other processes or methods as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform method 1200 of FIG. 12, method 1300 of FIG. 13, or other processes or methods as described herein. In some examples, executing instructions may include running the instructions, converting the instructions, compiling the instructions, and/or interpreting the instructions, among other examples.

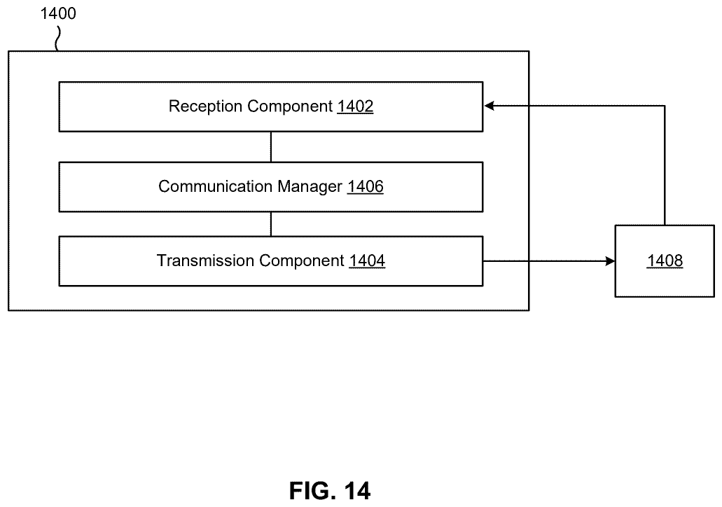

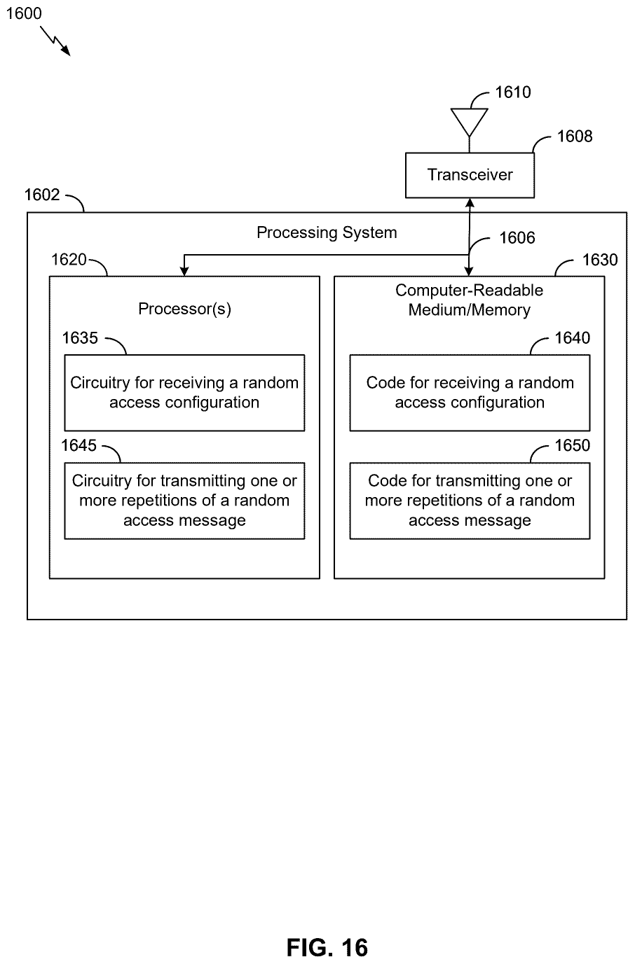

In some aspects, the UE 120 includes means for receiving, from a network node, a random access configuration including at least one partition of RACH resources, wherein the at least one partition includes a partition for SBFD operation, and wherein the partition for SBFD operation is associated with repetitions; and/or means for transmitting, in accordance with the random access configuration, one or more repetitions of multiple repetitions of a random access message using one or more RACH resources as indicated by the partition for SBFD operation. The means for the UE 120 to perform operations described herein may include, for example, one or more of communication manager 150, processing system 140, processing system 1602 described in connection with FIG. 16, a radio, one or more RF chains, one or more transceivers (e.g., transceiver 1608 described in connection with FIG. 16), one or more antennas (e.g., antenna 1610 described in connection with FIG. 16), one or more modems, a reception component (for example, reception component 1402 depicted and described in connection with FIG. 14), a transmission component (for example, transmission component 1404 depicted and described in connection with FIG. 14), one or more processors 1620 described in connection with FIG. 16, and/or computer-readable medium/memory 1630 described in connection with FIG. 16, among other examples.

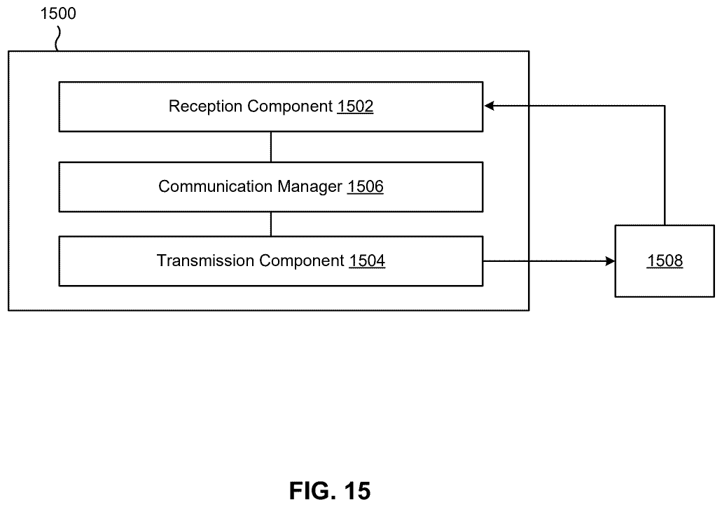

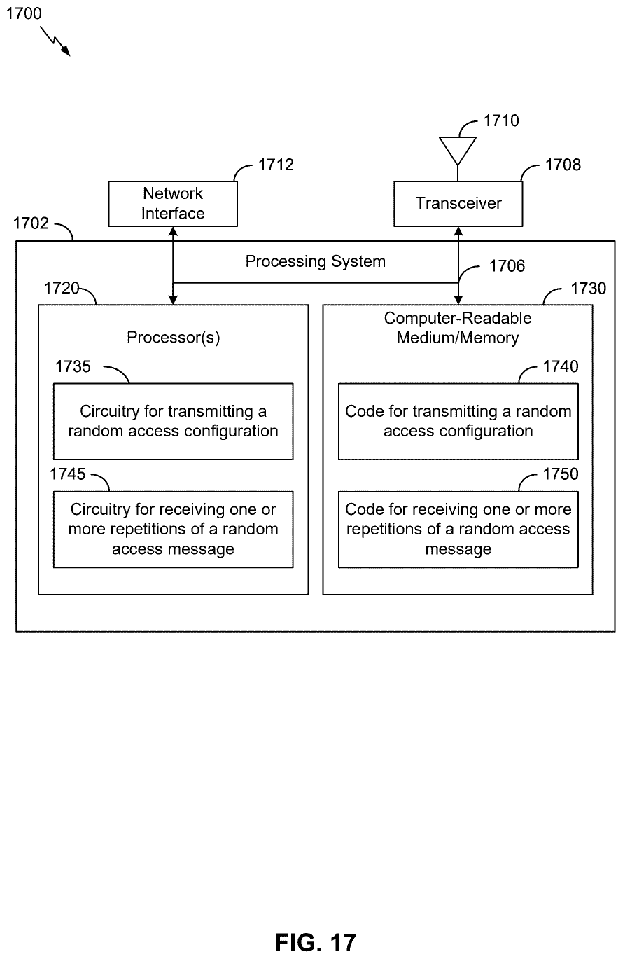

In some aspects, the network node 110 includes means for transmitting a random access configuration including at least one partition of RACH resources, wherein the at least one partition includes a partition for SBFD operation, and wherein the partition for SBFD operation is associated with repetitions; and/or means for receiving, in accordance with the random access configuration, one or more repetitions of multiple repetitions of a random access message, associated with a UE, using one or more RACH resources as indicated by the partition for SBFD operation. The means for the network node 110 to perform operations described herein may include, for example, one or more of communication manager 155, processing system 145, processing system 1702 described in connection with FIG. 17, a network interface (e.g., network interface 1712 described in connection with FIG. 17), a radio, one or more RF chains, one or more transceivers (e.g., transceiver 1708 described in connection with FIG. 17), one or more antennas (e.g., antenna 1710 described in connection with FIG. 17), one or more modems, a reception component (for example, reception component 1502 depicted and described in connection with FIG. 15), a transmission component (for example, transmission component 1504 depicted and described in connection with FIG. 15), one or more processors 1720 described in connection with FIG. 17, and/or computer-readable medium/memory 1730 described in connection with FIG. 17, among other examples.

FIG. 3 is a diagram illustrating an example 300 of selection of a number of repetitions for transmitting a random access (RA) message, in accordance with the present disclosure.

Random access procedures between a UE) and a network node may enable the UE and the network node to establish initial communication links, recover lost connections, and/or perform tasks, such as beam failure recovery, among other examples. A random access procedure may be performed to enable the UE to gain synchronization (e.g., time domain synchronization and/or frequency domain synchronization) with the network node. The configuration of random access procedures may be indicated via system information signaling from the network node, which specify the resources and timing for one or more RACH occasions. A random access procedure may include the transmission of a preamble by the UE, reception of a random access response from the network node by the UE, potentially further signaling for contention resolution, and a resource allocation for uplink communication. The UE and the network node performing the random access procedure may enable efficient utilization of network resources while accommodating multiple UEs in a synchronized manner, thus maintaining the integrity and performance of the wireless communication system.

A random access procedure may include a two-step random access procedure, a four-step random access procedure, and/or another type of random access procedure. The random access procedure may be a contention-based random access procedure (e.g., where a set of random access resources is configured for multiple UEs and each UE may select a random access resource (such as a preamble) from the set of random access resources for performing a random access procedure) or a contention-free random access procedure (e.g., where the network node configures random access resources specifically for a given UE).

As shown in FIG. 3, and by reference number 305, a network node may transmit SSBs and/or system information. For example, the network node may broadcast system information via a system information block (SIB), a master information block (MIB), and/or one or more SSBs, among other examples. The system information may include a random access configuration. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure. The random access configuration may indicate one or more random access resources, such as one or more preambles, and/or one or more RACH occasions, among other examples. The preamble may sometimes be referred to as a random access preamble, a PRACH preamble, or a random access message (RAM) preamble, among other examples. The one or more RACH occasions may indicate time domain resources and/or frequency domain resources, among other examples, that are available for the UE to transmit a random access message, such as a random access message that includes a preamble.

The random access configuration may indicate one or more partitions of random access resources (e.g., one or more RACH partitions). As used herein, “random access resource” refers to one or more resources used, configured, and/or allocated for performing a random access procedure. A random access resource may include a RACH occasion (e.g., one or more time-frequency resources, spatial domain resources, and/or code domain resources allocated and/or configured for a UE to transmit an RA message), and/or a preamble (e.g., a preamble index), among other examples. A RACH occasion may also be referred to herein as a random access transmission opportunity, and/or a PRACH occasion, among other examples. As used herein, a “partition” of random access resources refers to a subset of random access resources from a set of random access resources configured or available for performing a random access procedure. For example, a network node may group (e.g., partition) a subset of random access resources for different device capabilities and/or features. By a UE using a random access resource configured in a given partition, the network node may identify that the UE supports a feature and/or device capability associated with the given partition.

For example, a partition may be indicated or configured via a feature combination parameter in a RACH configuration. The feature combination parameter may be a featureCombinationPreambleList-r17 parameter. The RACH configuration may be a common RACH configuration (e.g., a rach-ConfigCommon) or an additional RACH configuration (e.g., an AdditionalRACH-ConfigList-r17). The feature combination parameter may indicate one or more features associated with the partition (e.g., via a featureCombination-r17 parameter). The feature combination parameter may indicate one or more preambles (e.g., one or more preamble indices) included in the partition (e.g., via a starting preamble parameter (a startPreambleForThisPartition-r17 parameter) and a number of preambles for each SSB parameter (e.g., a numberOfPreamblesPerSSB-ForThisPartition-r17 parameter)). Repetitions of a random access message may be considered a feature, as indicated by the featureCombination-r17 parameter. Different repetition numbers may be considered or treated as different RACH types. For example, different repetition numbers may have random access resources configured via separate partitions (e.g., via separate featureCombinationPreambles-r17 parameters). Random access resources that are configured with the same feature (e.g., the same featureCombination-r17 parameter) may be considered to be within the same set of random access resources. In some examples, for a partitions associated with multiple numbers of repetitions, one or parameters (e.g., defined via a rach-ConfigGeneric parameter) may be common for the multiple numbers of repetitions. For example, a deltaPreamble information element (IE) in a FeatureCombinationPreambles IE may be common for repetition number 2, 4 and 8. The numberOfRA-PreamblesGroupA parameter can be configured separately for different repetition numbers. The same value of a target receive power parameter(s) (e.g., a preamble ReceiveTargetPower parameter and/or a powerRampingStep parameter) can be applied for different repetition numbers.

As shown in FIG. 3, a first RACH partition 310 may be associated with one or more features, such as RedCap support and repetitions of an RA message, such as a msg1 RA message (e.g., a random access message payload, a first message, an initial message, and/or an RA message that includes a preamble). The first RACH partition 310 may be associated with a set of candidate RACH resources for four-step RACH, with the set of candidate RACH resources supporting msg1 with 2 repetitions (reps=2), with 4 repetitions (reps=4), or with 8 repetitions (reps=8). The different numbers of repetitions may be treated as different RACH types within the same feature (e.g., support for multiple repetitions).

As shown in FIG. 3, a second RACH partition 315 may be associated with features, such as slice support and msg1 repetitions. The second RACH partition 315 may be associated with a set of candidate RACH resources for four-step RACH, with the set of candidate RACH resources supporting msg1 with 2 repetitions reps=2 or with 4 repetitions.

At 320, the UE may identify features for an RA message (e.g., a first RA message). For example, the UE may identify one or more features that the UE desires to use for transmitting the RA message, such as RedCap support, slice support, and/or repetition support for the first RA message, among other examples.

At 325, the UE may select a RACH partition supporting the features for the RA message. For example, the UE may select the RACH partition from a set of candidate RACH partitions, with the selection based at least in part on matching the features desired for a RACH procedure with the RACH partition.

At 330, the UE may transmit the RA message using RACH resources from the selected RACH partition. For example, the UE may transmit the RA message using RACH resources associated with 2 repetitions as an initial attempt for transmission of the RA message. In some networks, based at least in part on the initial attempt for transmission of the RA message failing (e.g., as identified by failing to receive an RAR in response to the first RA message), the UE may select a different resource within the selected RACH partition to increase a number of repetitions.

The network node may identify the feature(s) for the RA message based on the random access resource(s) used to transmit the RA message. For example, if the random access resource(s) are included in the first partition 310 and configured for four repetitions, then the network node may identify that the UE is a RedCap type of UE and is going to transmit four repetitions of the RA message. As another example, if the random access resource(s) are included in the second partition 315 and configured for two repetitions, then the network node may identify that the UE is using slice support for the RA message and is going to transmit two repetitions of the RA message. This enables the network node to identify features and/or a number of repetitions for RA messages without explicit indications or signaling from the UE. This enables the network node to efficiently and correctly process (e.g., combine repetitions) the RA message(s) transmitted by the UE.

As indicated above, FIG. 3 is provided as an example. Other examples may differ from what is described with regard to FIG. 3.

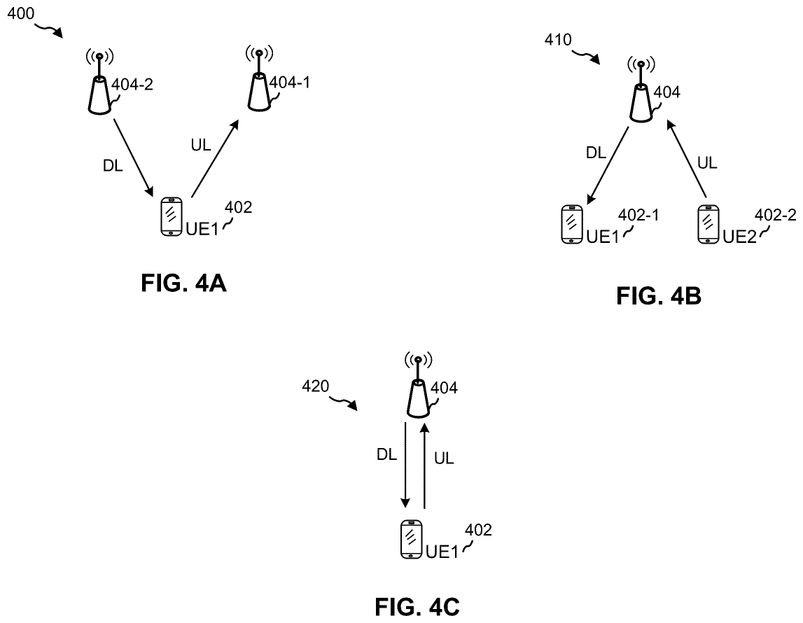

FIGS. 4A-4C are diagrams illustrating examples 400, 410, 420 of full-duplex communication, in accordance with the present disclosure. The example 400 of FIG. 4A includes a UE1 402 and two network nodes (e.g., TRPs) 404-1, 404-2, where the UE1 402 is sending uplink transmissions to network node 404-1 and is receiving downlink transmissions from base station 404-2. In the example 400 of FIG. 4A, full-duplex operation is enabled for the UE1 402, but not for the network node 404-1 and network node 404-2. The example 410 of FIG. 4B includes two UEs, shown as UE1 402-1 and UE2 402-2, and a network node 404, where the UE1 402-1 is receiving a downlink transmission from the network node 404 and the UE2 402-2 is transmitting an uplink transmission to the network node 404. In the example 410 of FIG. 4B, full-duplex operation is enabled for the network node 404, but not for UE1 402-1 and UE2 402-2. The example 420 of FIG. 4C includes a UE1 402 and a network node 404, where the UE1 402 is receiving a downlink transmission from the network node 404 and the UE1 402 is transmitting an uplink transmission to the network node 404. In the example 420 of FIG. 4C, full-duplex operation is enabled for both the UE1 402 and the network node 404.

As indicated above, FIGS. 4A-4C are provided as one or more examples. Other examples may differ from what is described with regard to FIGS. 4A-4C.

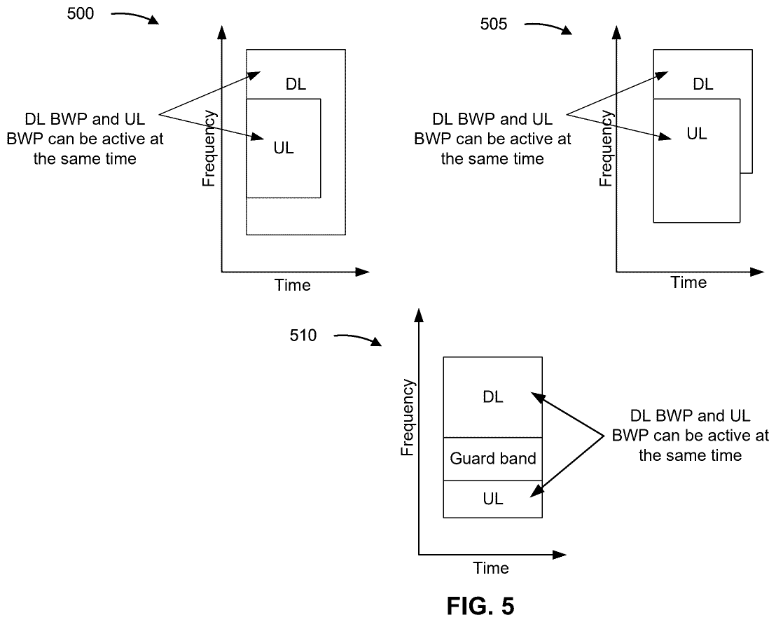

FIG. 5 is a diagram illustrating examples 500, 505, and 510 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 5, examples 500 and 505 show examples of in-band full-duplex (IBFD) communication. In IBFD, a UE may transmit an uplink communication to a base station and receive a downlink communication from the base station on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of SBFD communication, which may also be referred to as “subband frequency division duplex (SBFDD)” or “flexible duplex.” In SBFD, a UE may transmit an uplink communication to a base station and receive a downlink communication from the base station at the same time, but on different frequency resources. For example, the different frequency resources may be subbands of a frequency band, such as a time division duplexing band. In this case, the frequency resources used for downlink communication may be separated from the frequency resources used for uplink communication, in the frequency domain, by a guard band.

As indicated above, FIG. 5 is provided as an example. Other examples may differ from what is described with respect to FIG. 5.

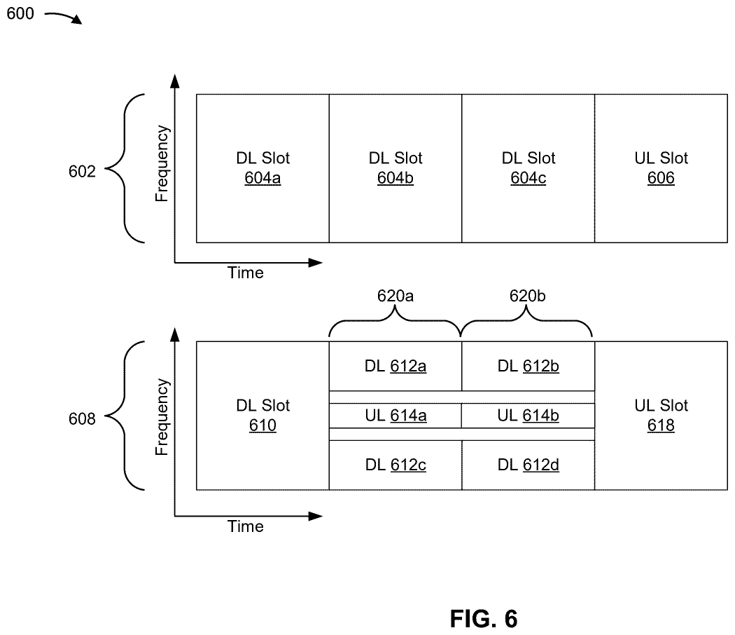

FIG. 6 is a diagram illustrating an example 600 of an SBFD structure, in accordance with the present disclosure. As shown in FIG. 6, example 600 includes a first slot structure 602. In some aspects, the first slot structure 602 may indicate a first slot format pattern (sometimes called a TDD pattern) associated with a half-duplex mode or a full-duplex mode. The first slot format pattern may include a quantity of downlink slots (e.g., three downlink slots 604a, 604b, and 604c, as shown in FIG. 6), a quantity of flexible slots (not shown), and/or a quantity of uplink slots (e.g., one uplink slot 606, as shown in FIG. 6). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

Although some aspects are described herein using a slot as an example time interval, the aspects and techniques described herein may be similarly applied to any time interval. The time interval may also be referred to as a time unit. For example, a time interval may include a frame, a subframe, a slot, a mini-slot (e.g., one or more symbols), a symbol (e.g., an OFDM symbol), a transmission time interval (TTI), a scheduling unit, and/or another time unit. For example, a slot (e.g., a downlink slot, an uplink slot, or an SBFD slot) may be a frame, a subframe, a mini-slot, one or more OFDM symbols, a TTI, and/or another time interval, in other examples. As used herein, “time interval” refers to a frame, a subframe, a slot, a mini-slot (e.g., one or more symbols), a symbol (e.g., an OFDM symbol), a TTI, a scheduling unit, and/or another time unit.

The network node 110 may configure a UE 120 with a second slot structure 608. In some examples, the network node 110 may transmit an indication for the UE 120 to switch from using the first slot structure 602 to using the second slot structure 608. As an alternative, the UE 120 may indicate to the network node 110 110 that the UE 120 is switching from using the first slot structure 602 to using the second slot structure 608. The second slot structure 608 may indicate a second slot format pattern that repeats over time, similar to the first slot format pattern. In any of the examples described above, the UE 120 may switch from the first slot structure 602 to the second slot structure 608 during a time period (e.g., a quantity of symbols and/or an amount of time (e.g., in ms)) based at least in part on an indication received from the network node 110 (e.g., before switching back to the first slot structure 602). During that time period, the UE 120 may communicate using the second slot format pattern, and then may revert to using the first slot format pattern after the end of the time period. The time period may be indicated by the network node 110 (e.g., in the instruction to switch from the first slot structure 602 to the second slot structure 608, as described above) and/or based at least in part on a programmed and/or otherwise preconfigured rule. For example, the rule may be based at least in part on a table (e.g., defined in 3GPP specifications and/or another wireless communication standard) that associates different SCSs and/or numerologies (e.g., represented by u and associated with corresponding SCSs) with corresponding time periods for switching configurations.

In example 600, the second slot structure 608 includes two SBFD slots 620 (shown as SBFD slot 620a and SBFD slot 620b) in place of what were downlink slots in the first slot format pattern. In example 600, each SBFD slot includes a partial slot (e.g., a portion or subband of a frequency allocated for use by the network node 110 and the UE 120) for downlink (e.g., partial slots 612a, 612b, 612c, and 612d, as shown) and a partial slot for uplink (e.g., partial slots 614a and 614b, as shown). A partial downlink slot 612 may be referred to as a downlink subband within an SBFD time interval (e.g., an SBFD slot or an SBFD symbol). A partial uplink slot 614 may be referred to as an uplink subband within an SBFD time interval (e.g., an SBFD slot or an SBFD symbol). Accordingly, the UE 120 may operate using the second slot format pattern to transmit an uplink communication in an earlier slot (e.g., the second slot in sequence, shown as partial uplink slot 614a) as compared to using the first slot format pattern (e.g., the fourth slot in sequence, shown as uplink slot 606). Other examples may include additional or alternative changes. For example, the second slot structure 608 may indicate an SBFD slot in place of what was an uplink slot in the first slot structure 602 (e.g., UL slot 606). In another example, the second slot structure 608 may indicate a downlink slot or an uplink slot in place of what was an SBFD slot in the first slot structure 602 (not shown in FIG. 6). In yet another example, the second slot structure 608 may indicate a downlink slot or an uplink slot in place of what was an uplink slot or a downlink slot, respectively, in the first slot structure 602. As shown in FIG. 6, the second slot structure 608 includes a downlink slot 610 and an uplink slot 618.

An “SBFD time interval” may refer to a time interval (e.g., a slot, a mini-slot, a subframe, an OFDM symbol, a transmission time interval, or another time interval) in which an SBFD format is used. An SBFD format may include a slot format in which full-duplex communication is supported (e.g., for both uplink and downlink communications), with one or more frequencies used for an uplink portion (e.g., an uplink subband) of the slot being separated from one or more frequencies used for a downlink portion (e.g., a downlink subband) of the slot by a guard band. A “portion” of a slot may refer to a portion of frequency resources, such as a subband. For example, an uplink portion may refer to a portion of frequency resources configured for uplink operation within the slot. In some examples, the SBFD format may include a single uplink portion and a single downlink portion separated by a guard band. In some examples, the SBFD format may include multiple downlink portions and a single uplink portion that is separated from the multiple downlink portions by respective guard bands (e.g., as shown in FIG. 6). In some examples, an SBFD format may include multiple uplink portions and a single downlink portion that is separated from the multiple uplink portions by respective guard bands. In some examples, the SBFD format may include multiple uplink portions and multiple downlink portions, where each uplink portion is separated from a downlink portion by a guard band. In some examples, operating using an SBFD mode may include activating or using a full-duplex mode in one or more slots based at least in part on the one or more slots having the SBFD format. A slot may support the SBFD mode if an uplink BWP and a downlink BWP are permitted to be or are simultaneously active in the slot in an SBFD fashion (e.g., with guard band separation).

By using the second slot structure 608, the network node 110 and the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second slot structure 608 rather than the first slot structure 602), and increased network resource utilization (e.g., by using both a downlink BWP and an uplink BWP simultaneously instead of only the downlink BWP or the uplink BWP).

In some examples, a UE 120 may support SBFD operation. In such examples, the UE 120 may be configured to use the second slot structure 608 for increased throughput and/or reduced latency for uplink communications. In other examples, a UE 120 may not support SBFD operation. In such examples, the network node 110 may refrain from configuring the UE 120 to use the second slot structure 608. Additionally, or alternatively, if the network node 110 configures the second slot structure, then a UE 120 that does not support SBFD operation may consider or identify SBFD slots (e.g., the SBFD slot 620a or the SBFD slot 620b) as downlink slots. This enables the UE 120 that does not support SBFD operation to receive downlink communications in a downlink portion of the SBFD slots without attempting to perform an SBFD operation that is not supported by the UE 120.

As indicated above, FIG. 6 is provided as an example. Other examples may differ from what is described with respect to FIG. 6.

FIG. 7 is a diagram illustrating an example 700 of RACH occasion groups, in accordance with the present disclosure.

As shown in FIG. 7, multiple RO groups may be defined in a frequency domain and in a time domain. An RO group may be associated with a periodic pattern. The RO group may include a first starting RO. The RO group may be a set of

$${N}_{preamble}^{rep}$$

valid ROs, or PRACH occasions, that are consecutive in time and use the same frequency resources. When a quantity of repetitions for an RA message (e.g., as indicated by an

$${N}_{preamble}^{rep}$$

parameter) is tour PRACH repetitions, two SSBs (e.g., SSB #0 and SSB #1) may be used as shown in FIG. 7 as an example. Each RO may have four frequency division multiplexed ROs (across RO groups), and an RO group may have four valid ROs. For other numbers of repetitions (e.g., two, eight, or another number), a different number of SSBs may be used and/or each RO group may include a different number of ROs.

For example, as shown in FIG. 7, a network node may configure SSB indices to be associated with respective time domain occasions 705 (shown in FIG. 7 as time domain occasions 705a, 705b, 705c, 705d, 705e, 705f, 705g, and 705h). The time domain occasion 705 and a frequency domain occasion associated with a given SSB index may be configured as an RO. As shown in FIG. 7, one or more RO groups 710 may be formed. In the example shown in FIG. 7, each RO group 710 (e.g., RO group 710a, RO group 710b, RO group 710c, and RO group 710d) may include two or more ROs (e.g., four ROs as shown in FIG. 7). An RO group may also be referred to as a set of valid ROs. When a UE transmits repetitions of an RA message, such as a Msg1, the UE may transmit the repetitions via respective ROs included in a given RO group 710. This enables the network node to identify the ROs in which repetitions of a given RA message are to be transmitted by the UE, thereby enabling the network node to efficiently and accurately combine the repetitions of the RA message for improved performance of the RA message.

In some examples, the UE may determine the RO groups 710 based on configuration information received from the network node. For example, ROs may be mapped consecutively per corresponding SSB index. The UE may determine the SSB-RO mapping based on identifying valid ROs. The UE may determine whether an RO is valid. For example, from a physical layer perspective at a UE, a four-step RACH procedure, also known as a Type-1 random access procedure, includes transmission of a random access preamble (Msg1) in a valid RO (sometimes called a PRACH occasion), reception of a random access response (RAR) message with a PDCCH/PDSCH (Msg2), and when applicable, transmission of a PUSCH scheduled by an uplink grant in the RAR (Msg3) and reception of a PDSCH for contention resolution (Msg4). Additionally, or alternatively, in a two-step RACH procedure, also known as a Type-2 random access procedure, a UE transmits a random access preamble in a valid RO and transmits a PUSCH payload (collectively referred to as MsgA) and the UE then receives a RAR message with a PDCCH/PDSCH (MsgB). Furthermore, when applicable, the UE transmits a PUSCH scheduled by a fallback uplink grant in the RAR and receives a PDSCH for contention resolution. In either case, when a RACH procedure is triggered (e.g., by higher layers at the UE and/or by a PDCCH order message received from a network node), the UE may determine an RO (e.g., corresponding to time and frequency resources for a PRACH transmission) in which to transmit the random access preamble, also known as a PRACH, according to an SSB-RO mapping.

For example, prior to initiation of a RACH procedure or transmission of a PRACH, a network node may provide a UE 120 with random access configuration information that indicates PRACH transmission parameters (e.g., a PRACH preamble format, time/frequency resources for PRACH transmission, a preamble index, and/or a preamble SCS, among other examples). Furthermore, the UE 120 may receive an indication of one or more SSB indexes in an ssb-PositionsInBurst parameter (e.g., indicated in a SIB type 1 (SIB1) and/or a ServingCellConfigCommon parameter) that are mapped to valid ROs. For example, the SSB indexes indicated in the ssb-PositionsInBurst parameter are mapped to valid ROs in an increasing order of preamble indexes within a single RO, then in an increasing order of frequency resource indexes for frequency multiplexed ROs, then in an increasing order of time resource indexes for time multiplexed ROs within a PRACH slot, and then in an increasing order of indexes for PRACH slots. In this way, when a PRACH transmission is triggered at the UE 120, the UE 120 may transmit a PRACH preamble in a valid RO that is mapped to an SSB index (e.g., an SSB index indicated in a PDCCH order triggering the PRACH transmission or an SSB index selected by the UE). Accordingly, because the UE transmits the PRACH preamble in a valid RO that is mapped to or otherwise associated with an SSB index, the UE may apply one or more validation rules to determine whether an RO is valid or invalid. For example, in paired spectrum or a supplementary uplink band, all ROs are valid. However, for unpaired spectrum (e.g., a TDD band), an RO must satisfy one or more validation rules to be considered valid.

For example, the validation rules that are applied to determine whether an RO is valid or invalid may depend on whether a UE has been provided with a parameter that indicates an uplink and downlink TDD configuration, or TDD pattern. For example, the uplink and downlink TDD configuration may be indicated in a tdd-UL-DL-ConfigurationCommon parameter, and may include a periodicity of a TDD pattern, a number of consecutive full downlink slots that begin each TDD pattern, a number of consecutive downlink symbols in the beginning of a slot that follows a last full downlink slot, a number of consecutive full uplink slots that end each TDD pattern, and a number of consecutive uplink symbols in the end of a slot that precedes a first full uplink slot. Accordingly, as described herein, the UE may apply a first set of validation rules to determine whether an RO is valid in cases where the uplink and downlink TDD configuration has not been provided, and may apply a second set of validation rules to determine whether an RO is valid in cases where the uplink and downlink TDD configuration has been provided.

For example, if the UE has not been provided with an uplink and downlink TDD configuration, an RO in a PRACH slot is valid if the RO does not precede an SSB in the PRACH slot and starts at least N_{gap} symbols after a last SSB reception symbol, where N_{gap} may have a value that depends on a preamble SCS (e.g., N_{gap} may have a value of 0 for a preamble SCS of 1.25 kilohertz (kHz) or 5 kHz, 2 for a preamble SCS of 15 kHz, 30 kHz, 60 kHz, or 120 kHz, 8 for a preamble SCS of 480 kHz, or 16 for a preamble SCS of 960 kHz). Furthermore, in cases where a semi-static channel access mode is configured, a valid RO cannot overlap with a set of consecutive symbols before the start of a next channel occupancy time where the UE does not transmit. Otherwise, an RO that fails to satisfy the applicable validation rules is considered invalid for SSB-RO mapping purposes and for PRACH transmission. For example, an RO may be invalid because the RO precedes an SSB in the PRACH slot. Furthermore, an RO may be invalid because the RO is fewer than N_{gap} symbols after a last SSB reception symbol. On the other hand, an RO that does not precede an SSB in a PRACH slot and is at least N_{gap} symbols after a last SSB reception symbol is considered valid.

Additionally, or alternatively, if the UE has been provided with an uplink and downlink TDD configuration, an RO is valid if the RO is within uplink symbols. For example, an RO may be valid because the RO is within uplink symbols. Alternatively, if an RO is not within uplink symbols (e.g., is within downlink or flexible symbols), then the RO is valid only if the RO does not precede an SSB in a PRACH slot and starts at least N_{gap} symbols after a last downlink symbol and least N_{gap} symbols after a last SSB symbol, where N_{gap} may have a value that depends on a preamble SCS. Furthermore, in cases where a semi-static channel access mode is configured, a valid RO cannot overlap with a set of consecutive symbols before the start of a next channel occupancy time where no transmissions are permitted. Otherwise, an RO that fails to satisfy the applicable validation rules is considered invalid for SSB-RO mapping purposes and for PRACH transmission. For example, an RO may be invalid because the RO precedes an SSB in the PRACH slot. Furthermore, an RO may be invalid because the RO is fewer than N_{gap} symbols after a last downlink symbol and fewer than N_{gap} symbols after a last SSB symbol. On the other hand, an RO that does not precede an SSB in a PRACH slot and is at least N_{gap} symbols after a last downlink symbol and a last SSB reception symbol is considered valid.

The indexing of the PRACH occasion indicated by a mask index value may be reset per mapping cycle of consecutive PRACH occasions per SSB index. The UE may select, for a transmission of an RA message (e.g., a PRACH transmission), an RO indicated by a PRACH mask index value for the indicated SSB index in the first available mapping cycle. For a given preamble index, the ordering of ROs may be: first, in increasing order of frequency resource indices for frequency multiplexed ROs; second, in increasing order of time resource indexes for time multiplexed ROs within a PRACH time interval (e.g., a PRACH slot); and third, in increasing order of indexes for PRACH slot.

For a PRACH transmission with

$${N}_{preamble}^{rep}$$

preamble repetitions, a set consists of

$${N}_{preamble}^{rep}$$

valid ROs that are consecutive in time, use same frequency resources, and are associated with same one or more SSB index(es). For example, if the

$${N}_{preamble}^{rep}$$

parameter indicates four repetitions, then the set of valid ROs may include four ROs. Each SSB index may associated with same preamble indexes in all valid ROs within the set. The set of valid ROs may form an RO group 710.

For a transmission of an RA message (e.g., a PRACH transmission) with preamble repetitions, a time period, starting from a frame 0, may be the smallest integer number of association pattern periods such that at least one set of valid PRACH occasions for each of the SSB indices can be determined within the time period for all configured number of preamble repetitions. The set(s) of valid PRACH occasions for each configured number of preamble repetitions may repeat every time period.

Within a time period, for set(s) of

$${N}_{preamble}^{rep}$$

valid ROs for a PRACH transmission with

$${N}_{preamble}^{rep}$$

preamble repetitions (e.g., for a given RO group 710), the first valid RO of the first set may be the first valid RO. The first valid RO of subsequent sets, if any, may be determined according to an ordering of valid ROs: first, in increasing order of frequency resource indexes for frequency multiplexed ROs; second, in increasing order of time resource indexes for time multiplexed ROs. For each frequency resource index for frequency multiplexed ROs, the first valid RO of the first set is the first valid RO, and the first valid PRACH occasion of subsequent sets, if any, is: after a number of consecutive valid ROs (e.g., indicated by a msg1-RepetitionTimeOffsetROGroup parameter) in time from the first valid RO of the previous set, where each RO is associated with same SSB index(es) and SSB index is associated with same preambles, if the msg1-RepetitionTimeOffsetROGroup parameter is provided; or is after the ROs for the previous set, if the msg1-RepetitionTimeOffsetROGroup parameter is not provided.

As indicated above, FIG. 7 is provided as an example. Other examples may differ from what is described with respect to FIG. 7.

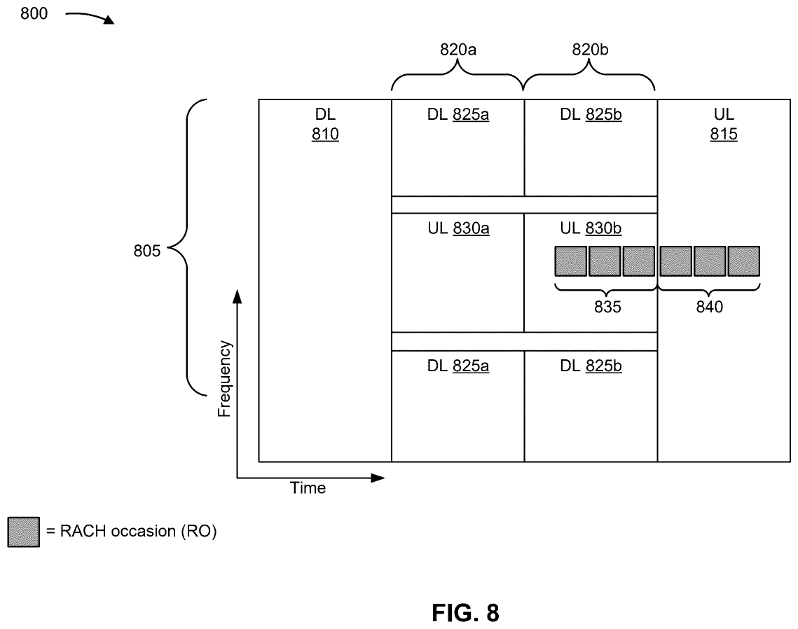

FIG. 8 is a diagram illustrating an example 800 of RACH occasions within SBFD time intervals, in accordance with the present disclosure. As shown in FIG. 8, a UE may be configured to use a slot structure 805. The slot structure 805 may also be referred to as a frame structure or a time domain structure or pattern. The slot structure 805 may be an SBFD slot structure, in a similar manner as described in connection with FIG. 6 and the second slot structure 608.

As shown in FIG. 8, the slot structure 805 may include a downlink time interval 810 (e.g., a downlink slot) and an uplink time interval 815 (e.g., an uplink slot). Additionally, the slot structure 805 may include one or more SBFD time intervals 820 (shown as a first SBFD time interval 820a and a second SBFD time interval 820b). Within each SBFD time interval 820, one or more downlink subbands 825 (shown as downlink subband(s) 825a and downlink subband(s) 825b) and one or more uplink subbands 830 (shown as uplink subband(s) 830a and uplink subband(s) 830b) may be configured. In some examples, some UEs may have an SBFD capability (e.g., referred to as “SBFD-aware” UEs or “SBFD-capable” UEs). Such UEs may be capable of processing signals received during an SBFD time interval 820 to receive signal(s) in a downlink subband 825 (e.g., and filter out signals from other subband(s) in the SBFD time interval 820) or to transmit signals in an uplink subband 830 of an SBFD time interval 820 (e.g., and not in downlink subband(s) 825 of the SBFD time interval 820). Other UEs may not have the SBFD capability (e.g., referred to as “non-SBFD-aware” UEs or “legacy” UEs). For example, a legacy UE may not be configured to process and/or decode configuration information indicating a structure of the SBFD time intervals 820 (e.g., a location of downlink subband(s) 825 and/or uplink subband(s) 830 within the SBFD time intervals 820). Therefore, the legacy UEs may consider SBFD time intervals 820 to be downlink time intervals (e.g., downlink slots).

As shown in FIG. 8, one or more ROs may be configured for UEs, in a similar manner as described elsewhere herein (such as in connection with FIGS. 3 and 7). As shown in FIG. 8, a first one or more ROs 835 may be configured to occur during the SBFD time interval 820b (e.g., in an uplink subband 830b of the SBFD time interval 820b). A second one or more ROs 840 may be configured to occur during the uplink time interval 815. SBFD-aware UEs may be capable of identifying and/or using both the first one or more ROs 835 and the second one or more ROs 840. However, legacy UEs (or non-SBFD-aware UEs) may only be capable of identifying and/or using the second one or more ROs 840 (e.g., and not the first one or more ROs 835).

In some examples, the first one or more ROs 835 and the second one or more ROs 840 may be configured together in a single configuration (e.g., a shared RO configuration). In such examples, different validation rules may be defined for SBFD-aware UEs and non-SBFD-aware UEs. For example, a first validation rule for SBFD-aware UEs may indicate that an RO that occurs within an uplink subband of an SBFD time interval may be valid (e.g., in accordance with one or more other validation rules, such as described in connection with FIG. 7). A second validation rule for legacy UEs (e.g., non-SBFD-aware UEs) may indicate that an RO that occurs within a downlink time interval is invalid (e.g., and the legacy UEs may consider the SBFD time interval(s) 820 to be downlink time intervals, as described elsewhere herein). Therefore, the first one or more ROs 835 may be valid for SBFD-aware UEs and may be invalid for non-SBFD-aware UEs.

In some other examples, the first one or more ROs 835 may be configured via a first configuration, and the second one or more ROs 840 may be configured via a second configuration. For example, two separate RACH configurations may define or indicate the first one or more ROs 835 and the second one or more ROs 840. For example, a legacy RACH configuration may define or indicate the second one or more ROs 840. An additional RACH configuration may define or indicate the first one or more ROs 835. Legacy UEs may not apply the additional RACH configuration (e.g., legacy UEs may not be capable of, or configured for, identifying and/or decoding the additional RACH configuration). Therefore, the second one or more ROs 840 may not be configured for the legacy UEs. SBFD-aware UEs may apply both the legacy RACH configuration and the additional RACH configuration. Therefore, both the first one or more ROs 835 and the second one or more ROs 840 may be configured for the SBFD-aware UEs.

However, having ROs that are valid for some UEs and not for other UEs increases the complexity associated with SSB-RO mapping and forming RO groups, such as for repetitions of a preamble in a PRACH transmission (e.g., as described in connection with FIG. 7). For example, as described elsewhere herein, random access resources for different repetition numbers may be configured via separate partitions of random access resources (e.g., as described in connection with FIG. 3). Random access resources of a partition that are configured via the same feature combination parameter may be considered to be within the same set of random access resources. Therefore, if a partition defines or indicates random access resources available to be used for a given number of repetitions of a random access message (e.g., of a preamble), it is expected that the random access resources are from the same set of random access resources for all UEs. This may result in a misalignment of formed RO groups among different UEs and/or between a UE and a network node because different UEs may consider a given RO valid, whereas other UEs may consider the given RO invalid (e.g., SBFD-aware UEs may consider an RO in an uplink subband 830b to be valid, whereas a legacy UE may consider the same RO to be invalid). The misalignment of formed RO groups may result in inefficient and/or degraded processing of repetitions of a random access message by the network node (e.g., because the network node may identify an RO group as including a first one or more ROs and the UE may identify the RO group as including a second one or more ROs). Alternatively, to address the potential misalignment, the set of random access resources for the partition may not include random access resources (e.g., ROs) configured to occur within SBFD time intervals. This may result in increased latency and/or inefficient resource utilization for SBFD-aware UEs because there may be ROs that could have otherwise been used for transmission by the SBFD-aware UEs (e.g., such as the first one or more ROs 835), but that are not included in the set of random access resources for the partition.

As indicated above, FIG. 8 is provided as an example. Other examples may differ from what is described with respect to FIG. 8.

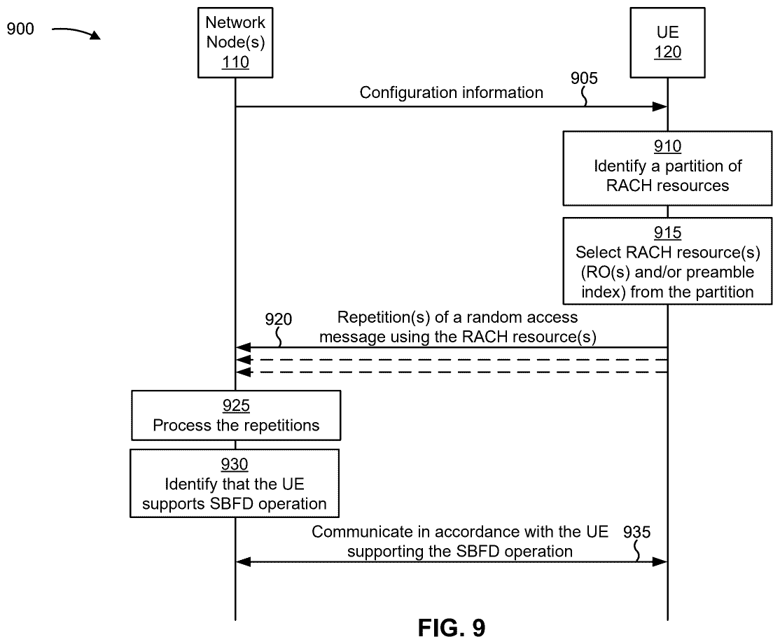

FIG. 9 is a diagram illustrating an example 900 associated with a random access configuration for SBFD, in accordance with the present disclosure. As shown in FIG. 9, a network node 110 (e.g., a base station, a CU, a DU, and/or an RU) may communicate with a UE 120. In some aspects, the network node 110 and the UE 120 may be part of a wireless network (e.g., the wireless communication network 100).

In some examples, the UE 120 may support an SBFD capability. For example, the UE 120 may be an SBFD-aware UE. The UE 120 may be capable of identifying and/or communicating via SBFD time intervals, such as SBFD slots and/or SBFD symbols, among other examples. The example 900 illustrates example signaling between the UE 120 and the network node 110 associated with a RACH configuration for SBFD operation.

At 905, the network node 110 may transmit, and the UE 120 may receive, configuration information. In some aspects, the UE 120 may receive the configuration information via one or more of system information (e.g., a MIB and/or a SIB, among other examples), RRC signaling, MAC signaling (e.g., one or more MAC-CEs), and/or lower layer signaling (e.g., DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

The configuration information may include a random access configuration (e.g., a RACH configuration). For example, the configuration information may include an uplink BWP configuration (e.g., a BWP-UplinkCommon IE or parameter). The uplink BWP configuration may include or indicate one or more random access configurations, such as a common RACH configuration (e.g., a rach-ConfigCommon IE or parameter), a generic RACH configuration (e.g., a rach-ConfigGeneric IE or parameter), and/or one or more additional RACH configurations (e.g., indicated by an AdditionalRACH-ConfigList IE or parameter), among other examples. The common RACH configuration may indicate one or more random access parameters for a cell supported by the network node 110 (e.g., one or more cell-specific random access parameters). The one or more additional RACH configurations may provide RACH configurations for different features or feature combinations.

In some examples, the configuration information may configure shared ROs for SBFD-aware UEs and legacy (or non-SBFD aware) UEs. For example, the configuration information may configure a set of ROs for SBFD-aware UEs and legacy (or non-SBFD aware) UEs using a single PRACH configuration index. Configuring shared ROs for SBFD-aware UEs and legacy (or non-SBFD aware) UEs may enable both SBFD-aware and legacy UEs to utilize the same resources for initiating random access procedures, thereby improving resource utilization and reducing bandwidth wastage, which may be beneficial in dense network environments. Additionally, shared ROs simplify network configuration and management by eliminating the need for the network node to maintain and configure separate configurations for different types of UEs, streamlining overall operations. The network node configuring shared ROs enables backward compatibility, allowing legacy UEs to operate effectively within the same network configuration as SBFD-aware UEs, facilitating a smooth transition as new technologies are introduced.

Moreover, the network node configuring shared ROs enables a unified signaling strategy for random access procedures, minimizing signaling overhead and reducing the likelihood of conflicts between different UEs. For SBFD-aware UEs, shared ROs offer enhanced uplink coverage and reliability, such as in challenging environments or at cell edges. The inclusion of both SBFD-aware and legacy UEs in the same RO configuration provides greater operational flexibility, allowing the network node to dynamically adapt to varying traffic conditions and capabilities without frequent reconfigurations. Further, by reducing the need for separate configurations, shared ROs can lower implementation and maintenance costs, streamlining network design and operations. Overall, configuring shared ROs enhances efficient resource utilization, simplifies management, ensures compatibility, and/or improves network performance and reliability, among other examples.

For example, to configure shared ROs for SBFD-aware UEs and legacy UEs, the network node 110 may transmit configuration information that includes a common RACH configuration (e.g., a rach-ConfigCommon IE or parameter). The common RACH configuration may indicate or include one or more partitions of random access resources. For example, the common RACH configuration may indicate or include one or more feature combination preamble list parameters (e.g., one or more featureCombinationPreamble List IEs or parameters). For example, the common RACH configuration may indicate or include a first feature combination preamble list parameter and a second feature combination preamble list parameter. The first feature combination preamble list parameter may indicate one or more partitions (e.g., one or more FeatureCombinationPreambles IEs or parameters) for legacy UEs (e.g., non-SBFD UEs). For example, the first feature combination preamble list parameter may indicate one or more partitions for non-SBFD operation. The first feature combination preamble list parameter may indicate one or more partitions for legacy TDD ROs (e.g., ROs configured in accordance with a TDD structure that does not include SBFD time intervals).

For example, the one or more partitions indicated by the first feature combination preamble list parameter may indicate one or more partitions for non-SBFD operation and one or more other features or UE capabilities. For example, the one or more partitions indicated by the first feature combination preamble list parameter may be associated with non-SBFD operation and: repetitions (e.g., Msg1 repetitions or preamble repetitions), one or more numbers of repetitions (e.g., two repetitions, four repetitions, eight repetitions, or another number of repetitions), RedCap types of UEs, small data transmissions, and/or network slide access stratum group (NSAG) support, among other examples.

The second feature combination preamble list parameter may indicate one or more partitions (e.g., one or more FeatureCombinationPreambles IEs or parameters) for SBFD-aware UEs (e.g., UEs that are capable of communicating during an SBFD time interval). For example, the second feature combination preamble list parameter may indicate one or more partitions for SBFD operation. The second feature combination preamble list parameter may indicate one or more partitions of random access resources configured in accordance with a slot or frame structure that includes SBFD time intervals.

For example, the one or more partitions indicated by the second feature combination preamble list parameter may indicate one or more partitions for SBFD operation and one or more other features or UE capabilities. For example, the one or more partitions indicated by the second feature combination preamble list parameter maybe associated with SBFD operation and: repetitions (e.g., Msg1 repetitions or preamble repetitions), one or more numbers of repetitions (e.g., two repetitions, four repetitions, eight repetitions, or another number of repetitions), RedCap types of UEs, small data transmissions, and/or NSAG support, among other examples.

For example, the RACH configuration (e.g., the common RACH configuration) may indicate or configure a first partition for SBFD operation and repetitions (e.g., Msg1 repetitions or preamble repetitions), such as via the second feature combination preamble list parameter. The RACH configuration (e.g., the common RACH configuration) may indicate or configure a second partition for non-SBFD operation and repetitions (e.g., Msg1 repetitions or preamble repetitions), such as via the first feature combination preamble list parameter. In some examples, the RACH configuration (e.g., the common RACH configuration) may indicate or configure a third partition for SBFD operation, repetitions (e.g., Msg1 repetitions or preamble repetitions), and RedCap device type support, such as via the second feature combination preamble list parameter. The RACH configuration (e.g., the common RACH configuration) may indicate or configure a fourth partition for non-SBFD operation, repetitions (e.g., Msg1 repetitions or preamble repetitions), and RedCap device type support, such as via the first feature combination preamble list parameter.

By the network node 110 configuring one or more partitions for SBFD operation via a separate feature combination preamble list parameter, the network node 110 may have increased flexibility and/or degrees of freedom for partitioning random access resources only for SBFD-aware UEs (e.g., for different and/or advanced features supported by the SBFD-aware UEs). Additionally, or alternatively, by the network node 110 configuring one or more partitions for SBFD operation via a separate feature combination preamble list parameter, the network node 110 may reduce the likelihood of overloading random access resources configured for legacy UEs (e.g., to reduce the likelihood of configuring a large number of UEs attempting to use the random access resources configured for legacy UEs).

In some other examples, the configuration information may configure separate ROs for SBFD-aware UEs and legacy (or non-SBFD aware) UEs. For example, the configuration information may configure a first set of ROs for SBFD-aware UEs using a first PRACH configuration index and a second set of ROs for legacy (or non-SBFD aware) UEs using a second PRACH configuration index. By the network node 110 configuring separate ROs for SBFD-aware UEs and legacy (or non-SBFD aware) UEs, the network node 110 can optimize resource utilization to match the varying capabilities of different UEs. For example, this enables SBFD-aware UEs to take full advantage of advanced features and frequency bands designed for SBFD operation, resulting in improved uplink coverage, reduced latency, and/or increased overall throughput. Meanwhile, legacy UEs can function within designated resources without interference, leading to more stable and reliable network performance. This separation also minimizes the risk of interference between SBFD and non-SBFD transmissions, ensuring that simultaneous transmission and reception on separate frequency subbands do not adversely affect legacy uplink or downlink communications.

Further, by the network node 110 configuring separate ROs, backward compatibility may be maintained, enabling legacy UEs to continue operating alongside the deployment of advanced features for SBFD-aware UEs. This coexistence facilitates a seamless transition to new technologies without disrupting existing services. By the network node 110 configuring separate ROs, the network node may simplify the configuration by enabling the network node 110 to set parameters and policies for each category of UE, reducing the complexities associated with managing a heterogeneous network. Additionally, with separate ROs, the network node 110 can dynamically adapt to changing traffic conditions and UE distributions. For example, an increase in SBFD-aware UEs in a particular area can prompt the network node 110 to allocate more ROs for these UEs, without affecting the resources available for legacy devices.

Additionally, by the network node 110 configuring separate ROs, the network node 110 may ensure Quality of Service (QoS) requirements are met for UEs having different capabilities and/or different QoS requirements. For example, SBFD-aware UEs, which potentially support high-bandwidth and low-latency applications, can be configured with resources to maintain high QoS levels, while legacy UEs can continue to receive adequate service levels. Overall, the separation of ROs for SBFD-aware and legacy UEs leads to optimized resource utilization, improved performance, reduced interference, enhanced compatibility, simplified management, dynamic adaptation, and/or better QoS assurance, contributing to a more robust, efficient, and scalable wireless communication network.

For example, ROs for SBFD-aware UEs may be configured separately via an additional RACH configuration (e.g., via an AdditionalRACHConfig IE or parameter). ROs for SBFD-aware UEs may be configured via a legacy RACH configuration (e.g., a legacy rach-ConfigCommon IE indicated by the AdditionalRACHConfig IE or parameter). The additional RACH configuration may indicate a separate SBFD-RACH configuration (e.g., an SBFD rach-ConfigCommon IE or parameter). The separate SBFD-RACH configuration may be configured specifically for SBFD operation. For example, the separate SBFD-RACH configuration may be an IE or parameter designed and/or designated only for SBFD operation (e.g., for SBFD aware UEs). As another example, additional RACH configuration may indicate a common RACH configuration (e.g., a legacy rach-ConfigCommon IE or parameter) with SBFD enabled. For example, the additional RACH configuration may indicate separate ROs for SBFD-aware UEs via a common RACH configuration that includes a feature, flag, or IE indicating that the common RACH configuration is applicable for SBFD operation and/or SBFD-aware UEs. In such examples, the RACH configuration (e.g., the SBFD rach-ConfigCommon IE or the legacy rach-ConfigCommon IE with SBFD enabled) may configure or indicate the one or more partitions for SBFD operation, as described in more detail elsewhere herein. In such examples, another RACH configuration (e.g., a legacy rach-ConfigCommon IE or parameter) may indicate one or more partitions for non-SBFD operation (e.g., in a similar manner as described in connection with FIG. 3).

At 910, the UE 120 may identify or select a partition of RACH resources to be used by the UE 120. For example, if the UE 120 supports an SBFD capability (e.g., is an SBFD-aware UE), then the UE 120 may identify or select a partition configured for SBFD operation. As another example, if the UE 120 does not support an SBFD capability (e.g., is a legacy UE or a non-SBFD UE), then the UE 120 may identify or select a partition configured for non-SBFD operation. In some examples, if the UE 120 does not support an SBFD capability (e.g., is a legacy UE or a non-SBFD UE), then the UE 120 may be unable to decode or otherwise obtain configuration information indicating the partitions for SBFD operation (e.g., a legacy UE may not decode or process the second feature combination preamble list parameter or the SBFD RACH configuration described elsewhere herein).

As another example, the UE 120 may determine a number of repetitions to be transmitted for a random access message (e.g., Msg1 or Msg3). The UE may determine the number of repetitions to use for a random access message via the configuration information, a signal quality assessment, and/or one or more adaptive strategies. For example, the configuration information may include one or more parameters for a RACH procedure, such as the number of repetitions to be associated with (e.g., to be transmitted) under various scenarios. The UE 120 may measure the current signal quality by evaluating metrics, such as RSRP, RSSI, and/or signal-to-noise ratio (SNR), among other examples. If the signal quality is poor, for example, then the UE 120 may determine that more repetitions are to be transmitted to ensure successful transmission and reception of the random access message.

Additionally, or alternatively, the network node 110 may indicate different RACH configurations with predefined repetition patterns for various conditions. In some aspects, the network node may transmit, and the UE 120 may receive, a dynamic indication (e.g., via DCI or one or more MAC-CEs), which may indicate the number of repetitions to be transmitted by the UE 120. In some aspects, the UE 120 may adjust the number of repetitions dynamically based on real-time feedback mechanisms, such automatic repeat request (ARQ) or HARQ. For example, if initial attempts to perform a RACH procedure fail, then the UE 120 may increase the number of repetitions in subsequent attempts. For example, the network node 110 may broadcast the RACH configuration, the UE 120 may measure current signal conditions, and the UE 120 may select an initial number of repetitions based on these factors (e.g., current signal conditions or other factors). If the initial random access attempt fails, then the UE 120 may adjust the number of repetitions for subsequent attempts.

The UE 120 may identify or select the partition based on the number of repetitions to be transmitted. For example, if the UE 120 is an SBFD-aware UE and is transmitting four repetitions of a random access message, then the UE 120 may select a partition configured for SBFD operation and that includes random access resources for four repetitions of the random access message. As another example, if the UE 120 is a non-SBFD-aware UE and is transmitting two repetitions of a random access message, then the UE 120 may select a partition configured for non-SBFD operation and that includes random access resources for two repetitions of the random access message.

Additionally, or alternatively, the UE 120 may identify or select the partition based on a device type of the UE 120. For example, the UE 120 may be a RedCap type of UE. The UE 120 may identify or select a partition that is associated with the RedCap type of UE (e.g., as indicated by a FeatureCombination IE). For example, if the UE 120 is an SBFD-aware UE and a RedCap UE, then the UE 120 may identify or select a partition that is configured for SBFD operation for the RedCap device type of UE (e.g., as indicated by a FeatureCombination IE for the partition). If the UE 120 is a non-SBFD-aware UE and a RedCap UE, then the UE 120 may identify or select a partition that is configured for non-SBFD operation (or legacy operation) for the RedCap device type of UE (e.g., as indicated by a FeatureCombination IE for the partition).

At 915, the UE 120 may select one or more RACH resources (e.g., random access resources) from the identified or selected partition. The UE 120 may determine one or more valid ROs from the RACH configuration. For example, if the UE 120 is an SBFD-aware UE, then the UE 120 may identify ROs configured for SBFD operation (e.g., via the shared RACH configuration as indicated by the partition(s) for SBFD operation or via the separate RACH configuration for SBFD operation). In such examples, the UE 120 may apply a validation rule in which ROs that are configured to occur in an uplink subband of an SBFD time interval can be valid ROs (e.g., in a similar manner as described in connection with FIGS. 7 and 8). If the UE 120 is a legacy UE or non-SBFD-aware UE, then the UE 120 may identify ROs configured for non-SBFD operation. In such examples, the UE 120 may apply a validation rule in which ROs that are configured to occur during an SBFD time interval are invalid ROs (e.g., in a similar manner as described in connection with FIGS. 7 and 8).

The UE 120 may perform an SSB-RO mapping to map one or more SSB indices to respective ROs (e.g., in a similar manner as described in connection with FIGS. 7 and 8). The UE 120 may identify or form one or more RO groups from the valid ROs (e.g., for SBFD operation or for non-SBFD operation). For example, if the UE 120 is an SBFD aware UE, then the UE 120 may identify or form one or more RO groups from the valid ROs configured for SBFD operation (e.g., via the shared RACH configuration, as indicated by the partition(s) for SBFD operation, or via the separate RACH configuration for SBFD operation). If the UE 120 is a legacy UE or non-SBFD aware UE, then the UE 120 may identify or form one or more RO groups from the valid ROs configured for non-SBFD operation.

The UE 120 may select one or more random access resources (e.g., one or more ROs and/or one or more preamble indices) from a set of random access resources indicated by the partition identified or selected at 910. For example, the UE 120 may identify a preamble index for random access message and an RO group indicating two or more ROs during which respective repetitions of the preamble (e.g., indicated by the preamble index) are to be transmitted. For example, the partition identified or selected at 910 may indicate a preamble index range for a given number of repetitions. The UE 120 may select a preamble index from the preamble index range. In some examples, the UE 120 may randomly select the preamble index from the preamble index range. The UE 120 may identify an RO group for the given number of repetitions (e.g., in a similar manner as described in connection with FIG. 7).

At 920, the UE 120 may transmit one or more repetitions of a random access message using the one or more random access resources selected at 915. The transmission of the one or more repetitions using the one or more random access resources selected at 915 may be indicative of the UE 120 supporting one or more features or capabilities. For example, if the one or more random access resources are selected from a partition associated with SBFD operation, then the transmission of the one or more repetitions may be indicative of the UE 120 supporting an SBFD capability. Alternatively, if the one or more random access resources are selected from a partition associated with non-SBFD operation, then the transmission of the one or more repetitions may be indicative of the UE 120 not supporting an SBFD capability. Additionally, or alternatively, if the one or more random access resources are selected from a partition associated with a RedCap device type feature, then the transmission of the one or more repetitions may be indicative of the UE 120 being a RedCap device type of UE.

Further, the transmission of the one or more repetitions using the one or more random access resources selected at 915 may be indicative of a number of repetitions to be transmitted by the UE 120. For example, if a preamble index associated with a preamble indicated by the random access message is selected from a preamble index range configured in a partition (e.g., for SBFD operation) for a given number of repetitions, then the transmission of a repetition (e.g., an initial transmission) including the preamble may be indicative that the UE 120 intends to transmit the given number of repetitions of the random access message (e.g., and may indicate that the UE 120 supports SBFD operation).

In some examples, the UE 120 may transmit multiple repetitions of the random access message. For example, the UE 120 may transmit a number of repetitions determined by the UE 120, as described in more detail elsewhere herein. For example, the UE 120 may transmit the multiple repetitions using respective ROs from an RO group. As described elsewhere herein, the UE 120 may determine or form the RO group from valid ROs configured for a given partition selected or identified by the UE 120 at 910 (e.g., in a similar manner as described in connection with FIG. 7).

In some aspects, at least one repetition of the multiple repetitions may be transmitted by the UE 120 during an SBFD time interval. For example, if the UE 120 is an SBFD-aware UE, then the UE 120 may determine that an RO that occurs during an SBFD time interval is valid. As a result, the UE 120 may use time-frequency resources indicated by the RO to transmit a repetition of the random access message.

At 925, the network node 110 may process the repetition(s). For example, the network node 110 may receive one or more repetitions of the random access message. The network node 110 may determine the random access resource(s) used by the UE 120 to transmit the one or more repetitions (e.g., the one or more random access resources selected by the UE 120 at 915). For example, the network node 110 may receive multiple repetitions of the same random access message, which the UE 120 transmits across different time or frequency resources (e.g., across different ROs from an RO group) to improve the likelihood of successful reception, such as in poor signal conditions or at the cell edge. Upon reception, the network node 110 may synchronize with the incoming PRACH signals and detect the presence of the random access message by identifying the specific time and frequency resources and the preamble index used by the UE.

Following detection of the presence of the random access message, the network node 110 may combine the repetitions to improve the signal quality and reliability of the received random access message. This process can involve coherent combining, where the network node 110 aligns the phase and amplitude of each repetition before adding the repetitions together if the network node 110 can accurately estimate the channel conditions. Alternatively, this process can involve non-coherent combining, in which the network node 110 sums the power of the repetitions without phase alignment when a precise channel estimation is not available at the network node 110. After combining the repetitions, the combined signal undergoes error detection and correction through one or more operations, such as cyclic redundancy check (CRC) and FEC codes, ensuring the integrity of the received data.

Once errors are detected and corrected, the network node 110 may interpret the content of the random access message, which may include the preamble indicating the intention of the UE 120 to initiate communication and possibly additional data payloads in some procedures. Upon successfully interpreting the random access message, the network node 110 may generate an RAR, containing information, such as a timing advance command, an initial grant for uplink transmission resources, and/or possibly an indication of whether the attempt of the UE 120 to initiate communication was successful. The network node 110 may transmit, and the UE 120 may receive, the RAR.

At 930, the network node 110 may identify that the UE 120 supports SBFD operation (e.g., that the UE 120 is an SBFD-aware UE) if the one or more repetitions use random access resources from a partition configured for SBFD operation. For example, if an RO and/or preamble index is configured in a partition for SBFD operation, as described elsewhere herein, then the network node 110 may identify or determine that the UE 120 is an SBFD-aware UE. Alternatively, if the one or more repetitions use random access resources from a partition configured for non-SBFD operation, then the network node 110 may identify or determine that the UE 120 is a legacy UE (e.g., a non-SBFD-aware UE).

The network node 110 may identify one or more other features or capabilities of the UE 120 based on the random access resources used by the UE 120 to transmit the one or more repetitions. For example, the network node 110 may identify the number of repetitions to be transmitted by the UE 120 based on the preamble index of the preamble included in the random access message. From the number of repetitions to be transmitted by the UE 120 (e.g., and an initial RO used for an initial transmission of the random access message), the network node 110 may determine the RO group to be used to communicate the multiple repetitions of the random access message (e.g., from valid ROs configured in the partition selected by the UE 120 at 910).

As another example, the network node 110 may identify that the UE 120 is a RedCap device type of UE based on the random access resources used by the UE 120 to transmit the one or more repetitions being configured in a partition that is associated with a feature of the RedCap device type. Additionally, or alternatively, the network node 110 may identify that the UE 120 supports small data transmissions, and/or NSAGs, among other examples, based on the partition in which the random access resources used by the UE 120 to transmit the one or more repetitions are configured.

In some examples, the network node 110 may determine one or more parameters for the RAR based on the feature(s) supported by the UE 120 (e.g., identified by the network node 110 at 930). For example, if the network node 110 determines that the UE 120 is an SBFD-aware UE, then the network node 110 may transmit the RAR during an SBFD time interval (e.g., in a downlink subband) and/or may allocate uplink resources for the UE 120 that occur during an SBFD time interval (e.g., in an uplink subband). This may reduce latency and/or improve resource utilization for the random access procedure. As another example, the network node 110 may determine that the UE 120 is a legacy UE (e.g., a non-SBFD-aware UE). In such examples, the network node 110 may transmit the RAR in a downlink time interval and/or may refrain from allocating uplink resources for the UE 120 that occur during an SBFD time interval.

At 935, the UE 120 and the network node 110 may communicate in accordance with the UE 120 supporting the SBFD operation. For example, the UE 120 and the network node 110 may perform the random access procedure, such as by transmitting or receiving one or more random access messages during one or more SBFD time intervals. Additionally, or alternatively, after establishing a connection via the random access procedure, the UE 120 and the network node 110 may communicate during one or more SBFD time intervals.

Alternatively, if the UE 120 is a legacy UE (e.g., a non-SBFD-aware UE), then the UE 120 and the network node 110 may perform the random access procedure, such as by refraining from transmitting or receiving one or more random access messages during one or more SBFD time intervals. Additionally, or alternatively, after establishing a connection via the random access procedure, the UE 120 and the network node 110 may not communicate during one or more SBFD time intervals. For example, the network node 110 may refrain from scheduling or allocating uplink resources for the UE 120 during SBFD time intervals.

Additionally, or alternatively, the UE 120 and the network node 110 may communicate in accordance with one or more other features indicated by the partition selected or identified by the UE 120 at 910. For example, if the partition selected or identified by the UE 120 at 910 is associated with a RedCap device type, then the UE 120 and the network node 110 may communicate in accordance with one or more parameters (e.g., transmit power, bandwidth size, SCS, or other parameter) for RedCap device type of UEs.

As indicated above, FIG. 9 is provided as an example. Other examples may differ from what is described with regard to FIG. 9.

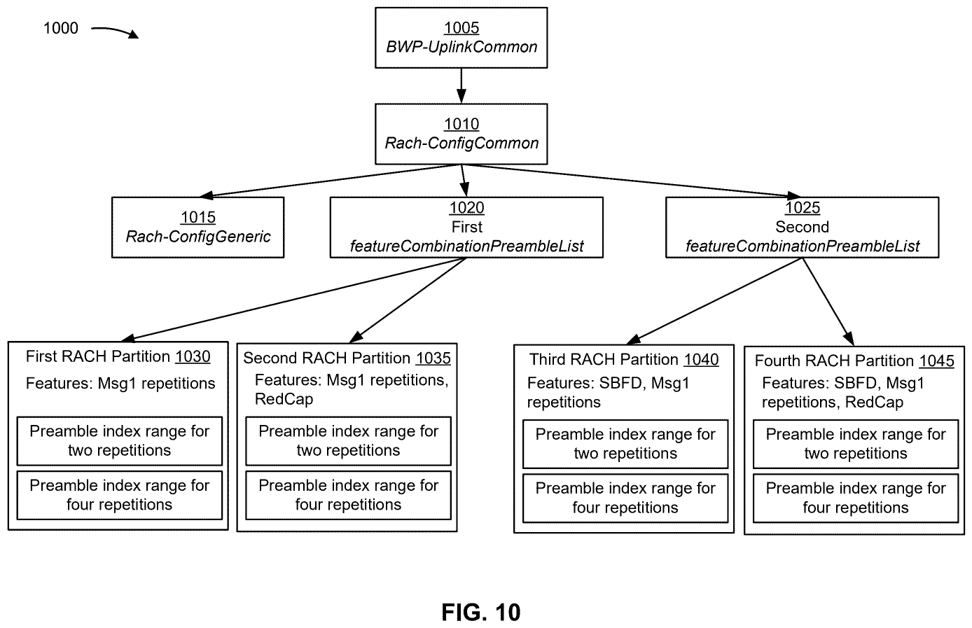

FIG. 10 is a diagram illustrating an example 1000 associated with a random access configuration for SBFD, in accordance with the present disclosure. The example 1000 is an example of single RACH configuration that configures shared ROs for SBFD-aware UEs and legacy UEs (e.g., non-SBFD aware UEs). The example 1000 depicts an example hierarchical structure of the RACH configuration.

As shown in FIG. 10, an uplink BWP configuration 1005 (e.g., indicated by a BWP-UplinkCommon IE) may indicate a common RACH configuration 1010 (e.g., indicated by a rach-ConfigCommon IE). The common RACH configuration 1010 may indicate one or more cell-specific random access parameters, IEs, or configurations. For example, the common RACH configuration 1010 may indicate a generic RACH configuration 1015 (e.g., indicated by a rach-ConfigGeneric IE). The generic RACH configuration 1015 may indicate a time domain PRACH configuration, such as one or more preamble formats and/or subframes to be used for random access.

The common RACH configuration 1010 may indicate multiple feature combination preamble lists, such as a first feature combination preamble list 1020 (e.g., indicated by a first featureCombinationPreambleList IE, such as featureCombinationPreambleList-r17) and a second feature combination preamble list 1025 (e.g., indicated by a second featureCombinationPreambleList IE). The first feature combination preamble list 1020 may indicate or configure one or more partitions of RACH resources for non-SBFD or legacy operation. The first feature combination preamble list 1020 and the second feature combination preamble list 1025 may be at the same hierarchical level of the common RACH configuration 1010.

The first feature combination preamble list 1020 may indicate or configure a first RACH partition 1030. The first RACH partition 1030 may be associated with the feature of Msg1 repetitions (e.g., as indicated by a FeatureCombination IE). The first RACH partition 1030 may indicate a first preamble index range for two repetitions of the Msg1 and a second preamble index range for four repetitions of the Msg1. Additionally, the first feature combination preamble list 1020 may indicate or configure a second RACH partition 1035. The second RACH partition 1035 may be associated with the feature of Msg1 repetitions for a RedCap device type (e.g., as indicated by a FeatureCombination IE). The second RACH partition 1035 may indicate a first preamble index range for two repetitions of the Msg1 and a second preamble index range for four repetitions of the Msg1.

The second feature combination preamble list 1025 may indicate or configure one or more partitions of RACH resources for SBFD operation. For example, the second feature combination preamble list 1025 may indicate or configure a third RACH partition 1040. The third RACH partition 1040 may be associated with the feature of Msg1 repetitions for SBFD operation (e.g., as indicated by a FeatureCombination IE). The third RACH partition 1040 may indicate a first preamble index range for two repetitions of the Msg1 and a second preamble index range for four repetitions of the Msg1. Additionally, the second feature combination preamble list 1025 may indicate or configure a fourth RACH partition 1045. The fourth RACH partition 1045 may be associated with the feature of Msg1 repetitions for a RedCap device type and SBFD operation (e.g., as indicated by a FeatureCombination IE). The fourth RACH partition 1045 may indicate a first preamble index range for two repetitions of the Msg1 and a second preamble index range for four repetitions of the Msg1.

In this way, the common RACH configuration 1010 may configure ROs for SBFD-aware UEs and legacy UEs via a single RACH configuration. For example, if a UE is an SBFD aware UE, then the UE may select one or more random access resources from the third RACH partition 1040 (e.g., if the UE is not a RedCap device type of UE) or the fourth RACH partition 1045 (e.g., if the UE is a RedCap device type of UE). Alternatively, if the UE is a legacy UE (e.g., a non-SBFD-aware UE), then the UE may select one or more random access resources from the first RACH partition 1030 (e.g., if the UE is not a RedCap device type of UE) or the second RACH partition 1035 (e.g., if the UE is a RedCap device type of UE). The feature(s) described herein are provided as examples and the partition(s) described herein may be associated with (e.g., configured for) other features or UE capabilities in a similar manner as described herein.

As indicated above, FIG. 10 is provided as an example. Other examples may differ from what is described with regard to FIG. 10.

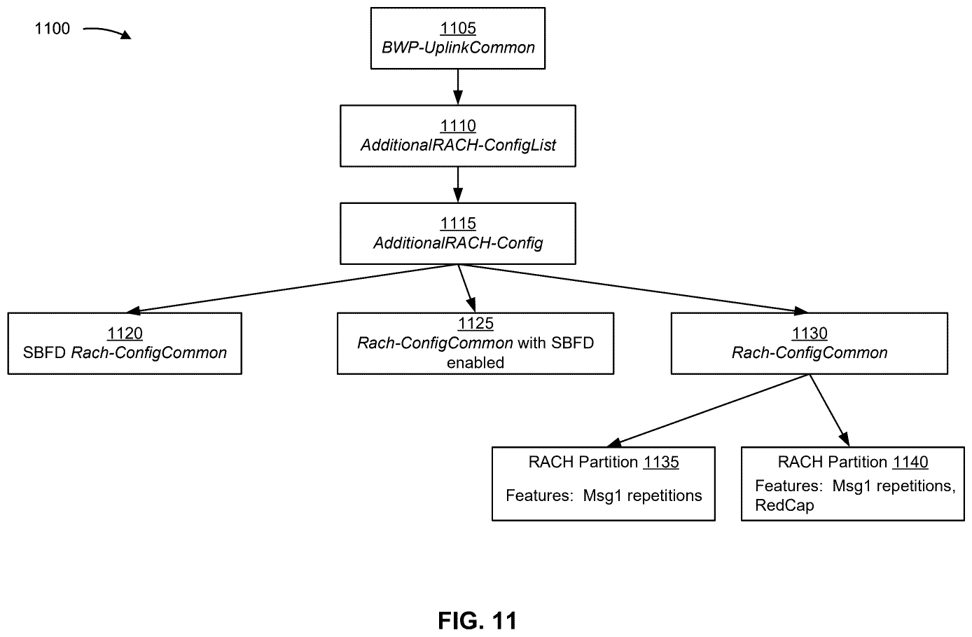

FIG. 11 is a diagram illustrating an example 1100 associated with a random access configuration for SBFD, in accordance with the present disclosure. The example 1100 is an example of separate RACH configurations that configure ROs for SBFD-aware UEs and legacy UEs (e.g., non-SBFD aware UEs). The example 1100 depicts an example hierarchical structure of the separate RACH configurations.

As shown in FIG. 11, an uplink BWP configuration 1105 (e.g., indicated by a BWP-UplinkCommon IE) may indicate a list 1110 of one or more additional RACH configurations (e.g., indicated by an AdditionalRACH-ConfigList IE). The list 1110 of one or more additional RACH configurations may indicate an additional RACH configuration 1115 (e.g., as indicated by an AdditionalRACH-Config IE). The additional RACH configuration 1115 may indicate a first RACH configuration for SBFD operation and a second RACH configuration for legacy operation (e.g., non-SBFD operation).

In some aspects, the first RACH configuration for SBFD operation may include an SBFD common RACH configuration 1120 (e.g., indicated by an SBFD rach-ConfigCommon IE). In such examples, the SBFD common RACH configuration 1120 may indicate one or more partitions of random access resources for SBFD operation, in a similar manner as described elsewhere herein. In some other aspects, the first RACH configuration for SBFD operation may include a common RACH configuration 1125 with SBFD enabled (e.g., as indicated by a rach-ConfigCommon IE). For example, the common RACH configuration 1125 may indicate that SBFD is enabled via a flag, IE, field, and/or other parameter indicated by, or included in, the common RACH configuration 1125. In such examples, the common RACH configuration 1125 may indicate one or more partitions of random access resources for SBFD operation, in a similar manner as described elsewhere herein.

In some aspects, the second RACH configuration for legacy operation may include a common RACH configuration 1130 (e.g., indicated by a rach-ConfigCommon IE). For example, as shown in FIG. 11, the common RACH configuration 1130 may indicate a first RACH partition 1135 (e.g., for Msg1 repetitions) and a second RACH partition 1140 (e.g., for Msg1 repetitions for a RedCap device type of UE). The first RACH partition 1135 and the second RACH partition 1140 may be configured for non-SBFD operation, in a similar manner as described in connection with FIG. 3.

For example, if a UE is an SBFD-aware UE, then the UE may identify one or more ROs for random access from the SBFD common RACH configuration 1120 or the common RACH configuration 1125. Alternatively, the UE is a legacy UE (e.g., a non-SBFD-aware UE), then the UE may identify one or more ROs for random access from the common RACH configuration 1130.

As indicated above, FIG. 11 is provided as an example. Other examples may differ from what is described with regard to FIG. 11.

FIG. 12 is a flowchart of an example method 1200 of wireless communication. The method 1200 may be performed at, for example, a UE (e.g., UE 120) or an apparatus of a UE.

Method 1200 begins at 1210 with receiving, from a network node, a random access configuration including at least one partition of RACH resources. For example, the UE may receive, from a network node, a random access configuration including at least one partition of RACH resources, wherein the at least one partition includes a partition for SBFD operation, and wherein the partition for SBFD operation is associated with repetitions, as described above in connection with, for example, FIG. 9 and at 905. In some aspects, the at least one partition includes a partition for SBFD operation. In some aspects, the partition for SBFD operation is associated with repetitions.

Method 1200 then proceeds at 1220 with transmitting, in accordance with the random access configuration, one or more repetitions of multiple repetitions of a random access message using one or more RACH resources as indicated by the partition for SBFD operation. For example, the UE may transmit, in accordance with the random access configuration, one or more repetitions of multiple repetitions of a random access message using one or more RACH resources as indicated by the partition for SBFD operation, as described above in connection with, for example, FIG. 9 and at 920.

In some aspects, the one or more repetitions are transmitted using the one or more RACH resources as indicated by the partition for SBFD operation.

In some aspects, transmitting the one or more repetitions indicates an SBFD capability of the UE.

In some aspects, method 1200 includes selecting, based on the UE supporting the SBFD operation, the one or more RACH resources indicated by the partition for SBFD operation.

In some aspects, the partition for SBFD operation is a first partition, and the random access configuration includes a second partition that is associated with non-SBFD operation.

In some aspects, the first partition and the second partition are each associated with repetitions.

In some aspects, method 1200 includes selecting, based on the UE supporting the SBFD operation, the first partition for the multiple repetitions.

In some aspects, the UE is a RedCap type of UE, the first partition is for SBFD operation of the RedCap device type of UE, and transmitting the one or more repetitions indicates the RedCap device type of UE.

In some aspects, the random access configuration includes a third partition that is associated with SBFD operation of a non-RedCap device type of UE.

In some aspects, the second partition is associated with non-SBFD operation of the RedCap device type of UE, and the random access configuration includes a fourth partition that is associated with non-SBFD operation of the non-RedCap device type of UE.

In some aspects, the UE is not a RedCap type of UE, the first partition is for SBFD operation of a non-RedCap device type of UE, and transmitting the one or more repetitions indicates the non-RedCap device type of UE.

In some aspects, the random access configuration includes a third partition that is associated with SBFD operation of a RedCap device type of UE.

In some aspects, the second partition is associated with non-SBFD operation of the non-RedCap device type of UE, and the random access configuration includes a fourth partition that is associated with non-SBFD operation of the RedCap device type of UE.

In some aspects, the random access configuration indicates a first feature combination preamble list that indicates the first partition and a second feature combination preamble list that indicates the second partition.

In some aspects, the random access configuration is included in a RACH-ConfigCommon information element.

In some aspects, the SBFD capability of the UE is associated with the UE supporting RACH resources in uplink time intervals and SBFD time intervals.

In some aspects, the random access configuration includes a first random access configuration that is associated with non-SBFD operation and a second random access configuration that is associated with the SBFD operation, and wherein the partition for SBFD operation is indicated by the second random access configuration.

In some aspects, the second random access configuration is included in an SBFD RACH-ConfigCommon information element.

In some aspects, the second random access configuration is included in a RACH-ConfigCommon information element with SBFD enabled.

In some aspects, the second random access configuration is included in a RACH-ConfigCommon information element.

In some aspects, transmitting the one or more repetitions includes transmitting a first repetition, of the multiple repetitions, via a first RACH occasion within an uplink subband of an SBFD time interval, wherein the partition for SBFD operation indicates the first RACH occasion.

In some aspects, transmitting the one or more repetitions includes transmitting a second repetition, of the multiple repetitions, via a second RACH occasion within an uplink time interval, wherein the partition for SBFD operation indicates the second RACH occasion.

In some aspects, the partition for SBFD operation is associated with a quantity of the multiple repetitions, the partition for SBFD operation indicates a set of RACH occasions and a preamble index range, and at least one RACH occasion, of the set of RACH occasions, occurs during an SBFD time interval.

In some aspects, the partition for SBFD operation includes a first partition for SBFD operation of a RedCap type of UE, and a second partition for SBFD operation of a non-RedCap type of UE, the UE is a non-RedCap type of UE, and the one or more RACH resources are indicated by the second partition.

In one aspect, method 1200, or any aspect related to it, may be performed by an apparatus, such as communications device 1600 of FIG. 16, which includes various components operable, configured, or adapted to perform the method 1200. Communications device 1600 is described below in further detail.

Although FIG. 12 shows example blocks of method 1200, in some aspects, method 1200 may include additional blocks, fewer blocks, different blocks, or differently arranged blocks than those depicted in FIG. 12. Additionally, or alternatively, two or more of the blocks of method 1200 may be performed in parallel.

FIG. 13 is a flowchart of an example method 1300 of wireless communication. The method 1300 may be performed at, for example, a network node (e.g., network node 110) or an apparatus of a network node.

Method 1300 begins at 1310 with transmitting a random access configuration including at least one partition of RACH resources. For example, the network node may transmit a random access configuration including at least one partition of RACH resources, wherein the at least one partition includes a partition for SBFD operation, and wherein the partition for SBFD operation is associated with repetitions, as described above in connection with, for example, FIG. 9 and at 905. In some aspects, the at least one partition includes a partition for SBFD operation. In some aspects, the partition for SBFD operation is associated with repetitions.

Method 1300 then proceeds at 1320 with receiving, in accordance with the random access configuration, one or more repetitions of multiple repetitions of a random access message, associated with a UE, using one or more RACH resources as indicated by the partition for SBFD operation. For example, the network node may receive, in accordance with the random access configuration, one or more repetitions of multiple repetitions of a random access message, associated with a UE, using one or more RACH resources as indicated by the partition for SBFD operation, as described above in connection with, for example, FIG. 9 and at 920.

In some aspects, the one or more repetitions are received using the one or more RACH resources as indicated by the partition for SBFD operation.

In some aspects, receiving the one or more repetitions indicates an SBFD capability of the UE.

In some aspects, method 1300 includes the partition for SBFD operation is a first partition, and the random access configuration includes a second partition that is associated with non-SBFD operation.

In some aspects, the first partition and the second partition are each associated with repetitions.

In some aspects, method 1300 includes the UE is a RedCap type of UE, the first partition is for SBFD operation of the RedCap device type of UE, and receiving the one or more repetitions indicates the RedCap device type of UE.

In some aspects, the random access configuration includes a third partition that is associated with SBFD operation of a non-RedCap device type of UE.

In some aspects, the second partition is associated with non-SBFD operation of the RedCap device type of UE, and the random access configuration includes a fourth partition that is associated with non-SBFD operation of the non-RedCap device type of UE.

In some aspects, the UE is not a RedCap type of UE, the first partition is for SBFD operation of a non-RedCap device type of UE, and receiving the one or more repetitions indicates the non-RedCap device type of UE.

In some aspects, the random access configuration includes a third partition that is associated with SBFD operation of a RedCap device type of UE.

In some aspects, the second partition is associated with non-SBFD operation of the non-RedCap device type of UE, and the random access configuration includes a fourth partition that is associated with non-SBFD operation of the RedCap device type of UE.

In some aspects, the random access configuration indicates a first feature combination preamble list that indicates the first partition and a second feature combination preamble list that indicates the second partition.

In some aspects, the random access configuration is included in a RACH-ConfigCommon information element.

In some aspects, the SBFD capability of the UE is associated with the UE supporting RACH resources in uplink time intervals and SBFD time intervals.

In some aspects, the random access configuration includes a first random access configuration that is associated with non-SBFD operation and a second random access configuration that is associated with the SBFD operation, and wherein the partition for SBFD operation is indicated by the second random access configuration.

In some aspects, the second random access configuration is included in an SBFD RACH-ConfigCommon information element.

In some aspects, the second random access configuration is included in a RACH-ConfigCommon information element with SBFD enabled.

In some aspects, the second random access configuration is included in a RACH-ConfigCommon information element.

In some aspects, receiving the one or more repetitions includes receiving a first repetition, of the multiple repetitions, via a first RACH occasion within an uplink subband of an SBFD time interval, wherein the partition for SBFD operation indicates the first RACH occasion.

In some aspects, receiving the one or more repetitions includes receiving a second repetition, of the multiple repetitions, via a second RACH occasion within an uplink time interval, wherein the partition for SBFD operation indicates the second RACH occasion.

In some aspects, the partition for SBFD operation is associated with a quantity of the multiple repetitions, the partition for SBFD operation indicates a set of RACH occasions and a preamble index range, and at least one RACH occasion, of the set of RACH occasions, occurs during an SBFD time interval.

In one aspect, method 1300, or any aspect related to it, may be performed by an apparatus, such as communications device 1700 of FIG. 17, which includes various components operable, configured, or adapted to perform the method 1300. Communications device 1700 is described below in further detail.

Although FIG. 13 shows example blocks of method 1300, in some aspects, method 1300 may include additional blocks, fewer blocks, different blocks, or differently arranged blocks than those depicted in FIG. 13. Additionally, or alternatively, two or more of the blocks of method 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 9-11. Additionally, or alternatively, the apparatus 1400 may be configured to perform one or more processes described herein, such as method 1200 of FIG. 12, or a combination thereof. In some aspects, the apparatus 1400 and/or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a network node, a random access configuration including at least one partition of RACH resources wherein the at least one partition includes a partition for SBFD operation, and wherein the partition for SBFD operation is associated with repetitions. The transmission component 1404 may transmit, in accordance with the random access configuration, one or more repetitions of multiple repetitions of a random access message using one or more RACH resources as indicated by the partition for SBFD operation.

The communication manager 1406 may select, based on the UE supporting the SBFD operation, the one or more RACH resources indicated by the partition for SBFD operation.

The communication manager 1406 may select, based on the UE supporting the SBFD operation, the first partition for the multiple repetitions.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network node.

In some aspects, the apparatus 1500 may be configured to perform one or more operations described herein in connection with FIGS. 9-11. Additionally, or alternatively, the apparatus 1500 may be configured to perform one or more processes described herein, such as method 1300 of FIG. 13, or a combination thereof. In some aspects, the apparatus 1500 and/or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a random access configuration including at least one partition of RACH resources wherein the at least one partition includes a partition for SBFD operation, and wherein the partition for SBFD operation is associated with repetitions. The reception component 1502 may receive, in accordance with the random access configuration, one or more repetitions of multiple repetitions of a random access message, associated with a UE, using one or more RACH resources as indicated by the partition for SBFD operation.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram illustrating an example of an implementation of code and circuitry for a communications device 1600, in accordance with the present disclosure. The communications device 1600 may be a UE, or a UE may include the communications device 1600.

The communications device 1600 includes a processing system 1602 coupled to a transceiver 1608 (e.g., a transmitter and/or a receiver, and which may include a single transceivers or multiple transceivers which may perform different operations described as being performed by the transceiver 1608). The processing system 1602 may be, or may be similar to, the processing system 140 of the UE 120. The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes one or more processors 1620. In various aspects, the one or more processors 1620 may include one or more of a receive processor, a transmit processor, a transmit (TX) MIMO processor, and/or a controller/processor, among other examples, such as one or more processors described in connection with the processing system 140. The one or more processors 1620 are coupled to a computer-readable medium/memory 1630 via a bus 1606. In various aspects, the computer-readable medium/memory 1630 may include one or more memories. In certain aspects, the computer-readable medium/memory 1630 is configured to store instructions (e.g., computer-executable code, processor-executable code) that when executed by the one or more processors 1620, cause the one or more processors 1620 to perform the method 1200 described with respect to FIG. 12, or any aspect related to it. Note that reference to a processor performing a function of communications device 1600 may include one or more processors performing that function of communications device 1600. Note also that reference to one or more processors performing multiple functions may include a first processor performing a first function of the multiple functions and a second processor performing a second function of the multiple functions.

As shown in FIG. 16, the communications device 1600 may include circuitry for receiving, from a network node, a random access configuration including at least one partition of RACH resources (circuitry 1635).

As shown in FIG. 16, the communications device 1600 may include, stored in computer-readable medium/memory 1630, code for receiving, from a network node, a random access configuration including at least one partition of RACH resources (code 1640).

As shown in FIG. 16, the communications device 1600 may include circuitry for transmitting, in accordance with the random access configuration, one or more repetitions of multiple repetitions of a random access message using one or more RACH resources as indicated by the partition for SBFD operation (circuitry 1645).

As shown in FIG. 16, the communications device 1600 may include, stored in computer-readable medium/memory 1630, code for transmitting, in accordance with the random access configuration, one or more repetitions of multiple repetitions of a random access message using one or more RACH resources as indicated by the partition for SBFD operation (code 1650).

Various components of the communications device 1600 may provide means for performing the method 1200 described with respect to FIG. 12, or any aspect related to it. For example, means for transmitting, sending, or outputting for transmission may include one or more components of the processing system 140 and/or the UE 120 (such as transceiver(s) and/or antenna(s) of the UE 120) and/or transceiver 1608 and antenna 1610 of the communications device 1600 in FIG. 16. Means for receiving or obtaining may include one or more components of the processing system 140 and/or the UE 120 (such as transceiver(s) and/or antenna(s) of the UE 120) and/or transceiver 1608 and antenna 1610 of the communications device 1600 in FIG. 16.

FIG. 16 is provided as an example. Other examples may differ from what is described in connection with FIG. 16.

FIG. 17 is a diagram illustrating an example of an implementation of code and circuitry for a communications device 1700, in accordance with the present disclosure. The communications device 1700 may be a network node (such as network node 110 or a disaggregated base station as described with regard to FIG. 2), or a network node may include the communications device 1700.

The communications device 1700 includes a processing system 1702 coupled to a transceiver 1708 (e.g., a transmitter and/or a receiver, and which may include a single transceivers or multiple transceivers which may perform different operations described as being performed by the transceiver 1708). The processing system may be, or may be similar to, the processing system 145 of the network node 110. The transceiver 1708 is configured to transmit and receive signals for the communications device 1700 via an antenna 1710 (e.g., one or more antennas), such as the various signals as described herein. The network interface 1712 is configured to obtain and send signals for the communications device 1700 via communications link(s), such as a backhaul link, midhaul link, and/or fronthaul link as described herein, such as with respect to FIG. 2. The processing system 1702 may be configured to perform processing functions for the communications device 1700, including processing signals received and/or to be transmitted by the communications device 1700.

The processing system 1702 includes one or more processors 1720. In various aspects, the one or more processors 1720 may include one or more of a receive processor, a transmit processor, a TX MIMO processor, and/or a controller/processor, among other examples, such as one or more processors described in connection with the processing system 145. The one or more processors 1720 are coupled to a computer-readable medium/memory 1730 via a bus 1706. In various aspects, the computer-readable medium/memory 1730 may include one or more memories. In certain aspects, the computer-readable medium/memory 1730 is configured to store instructions (e.g., computer-executable code, processor-executable code) that when executed by the one or more processors 1720, cause the one or more processors 1720 to perform the method 1300 described with respect to FIG. 13, or any aspect related to it. Note that reference to a processor performing a function of communications device 1700 may include one or more processors performing that function of communications device 1700. Note also that reference to one or more processors performing multiple functions may include a first processor performing a first function of the multiple functions and a second processor performing a second function of the multiple functions.

As shown in FIG. 17, the communications device 1700 may include circuitry for transmitting a random access configuration including at least one partition of RACH resources (circuitry 1735).

As shown in FIG. 17, the communications device 1700 may include, stored in computer-readable medium/memory 1730, code for transmitting a random access configuration including at least one partition of RACH resources (code 1740).

As shown in FIG. 17, the communications device 1700 may include circuitry for receiving, in accordance with the random access configuration, one or more repetitions of multiple repetitions of a random access message, associated with a UE, using one or more RACH resources as indicated by the partition for SBFD operation (circuitry 1745).

As shown in FIG. 17, the communications device 1700 may include, stored in computer-readable medium/memory 1730, code for receiving, in accordance with the random access configuration, one or more repetitions of multiple repetitions of a random access message, associated with a UE, using one or more RACH resources as indicated by the partition for SBFD operation (code 1750).

Various components of the communications device 1700 may provide means for performing the method 1300 described with respect to FIG. 13, or any aspect related to it. For example, means for transmitting, sending, or outputting for transmission may include one or more components of the processing system 145 and/or the network node 110 (such as transceiver(s) and/or antenna(s) of the network node 110) and/or the transceiver 1708 and/or antenna 1710 of the communications device 1700 in FIG. 17. Means for receiving or obtaining may include one or more components of the processing system 145 and/or the network node 110 (such as transceiver(s) and/or antenna(s) of the network node 110) and/or the transceiver 1708 and/or antenna 1710 of the communications device 1700 in FIG. 17.

FIG. 17 is provided as an example. Other examples may differ from what is described in connection with FIG. 17.

The following provides an overview of some Aspects of the present disclosure:
Aspect 1: A method of wireless communication performed by a user equipment (UE), comprising: receiving, from a network node, a random access configuration including at least one partition of random access channel (RACH) resources, wherein the at least one partition includes a partition for subband full duplex (SBFD) operation, and wherein the partition for SBFD operation is associated with repetitions; and transmitting, in accordance with the random access configuration, one or more repetitions of multiple repetitions of a random access message using one or more RACH resources as indicated by the partition for SBFD operation.
Aspect 2: The method of Aspect 1, wherein the one or more repetitions are transmitted using the one or more RACH resources as indicated by the partition for SBFD operation.
Aspect 3: The method of Aspect 2, wherein transmitting the one or more repetitions indicates an SBFD capability of the UE.
Aspect 4: The method of any of Aspects 2-3, comprising: selecting, based on the UE supporting the SBFD operation, the one or more RACH resources indicated by the partition for SBFD operation.
Aspect 5: The method of any of Aspects 1-4, wherein: the partition for SBFD operation is a first partition; and the random access configuration includes a second partition that is associated with non-SBFD operation.
Aspect 6: The method of Aspect 5, wherein the first partition and the second partition are each associated with repetitions.
Aspect 7: The method of Aspect 6, comprising: selecting, based on the UE supporting the SBFD operation, the first partition for the multiple repetitions.
Aspect 8: The method of any of Aspects 5-7, wherein: the UE is a reduced capability (RedCap) type of UE; the first partition is for SBFD operation of the RedCap device type of UE; and transmitting the one or more repetitions indicates the RedCap device type of UE.
Aspect 9: The method of Aspect 8, wherein the random access configuration includes a third partition that is associated with SBFD operation of a non-RedCap device type of UE.
Aspect 10: The method of Aspect 9, wherein: the second partition is associated with non-SBFD operation of the RedCap device type of UE; and the random access configuration includes a fourth partition that is associated with non-SBFD operation of the non-RedCap device type of UE.
Aspect 11: The method of any of Aspects 5-7, wherein: the UE is not a reduced capability (RedCap) type of UE; the first partition is for SBFD operation of a non-RedCap device type of UE; and transmitting the one or more repetitions indicates the non-RedCap device type of UE.
Aspect 12: The method of Aspect 11, wherein the random access configuration includes a third partition that is associated with SBFD operation of a RedCap device type of UE.
Aspect 13: The method of Aspect 12, wherein: the second partition is associated with non-SBFD operation of the non-RedCap device type of UE; and the random access configuration includes a fourth partition that is associated with non-SBFD operation of the RedCap device type of UE.
Aspect 14: The method of any of Aspects 5-13, wherein the random access configuration indicates a first feature combination preamble list that indicates the first partition and a second feature combination preamble list that indicates the second partition.
Aspect 15: The method of Aspect 14, wherein the random access configuration is included in a RACH-ConfigCommon information element.
Aspect 16: The method of any of Aspects 3-15, wherein the SBFD capability of the UE is associated with the UE supporting RACH resources in uplink time intervals and SBFD time intervals.
Aspect 17: The method of any of Aspects 1-16, wherein the random access configuration includes a first random access configuration that is associated with non-SBFD operation and a second random access configuration that is associated with the SBFD operation, and wherein the partition for SBFD operation is indicated by the second random access configuration.
Aspect 18: The method of Aspect 17, wherein the second random access configuration is included in an SBFD RACH-ConfigCommon information element.
Aspect 19: The method of Aspect 17, wherein the second random access configuration is included in a RACH-ConfigCommon information element with SBFD enabled.
Aspect 20: The method of Aspect 17, wherein the second random access configuration is included in a RACH-ConfigCommon information element.
Aspect 21: The method of any of Aspects 1-20, wherein transmitting the one or more repetitions comprises: transmitting a first repetition, of the multiple repetitions, via a first RACH occasion within an uplink subband of an SBFD time interval, wherein the partition for SBFD operation indicates the first RACH occasion.
Aspect 22: The method of Aspect 21, wherein transmitting the one or more repetitions comprises: transmitting a second repetition, of the multiple repetitions, via a second RACH occasion within an uplink time interval, wherein the partition for SBFD operation indicates the second RACH occasion.
Aspect 23: The method of any of Aspects 1-22, wherein; the partition for SBFD operation is associated with a quantity of the multiple repetitions; the partition for SBFD operation indicates a set of RACH occasions and a preamble index range; and at least one RACH occasion, of the set of RACH occasions, occurs during an SBFD time interval.
Aspect 24: The method of any of Aspects 1-23, wherein: the partition for SBFD operation includes a first partition for SBFD operation of a reduced capability (RedCap) type of UE, and a second partition for SBFD operation of a non-RedCap type of UE; the UE is a non-RedCap type of UE; and the one or more RACH resources are indicated by the second partition.
Aspect 25: A method of wireless communication performed by a network node, comprising: transmitting a random access configuration including at least one partition of random access channel (RACH) resources, wherein the at least one partition includes a partition for subband full duplex (SBFD) operation, and wherein the partition for SBFD operation is associated with repetitions; and receiving, in accordance with the random access configuration, one or more repetitions of multiple repetitions of a random access message, associated with a user equipment (UE), using one or more RACH resources as indicated by the partition for SBFD operation.
Aspect 26: The method of Aspect 25, wherein the one or more repetitions are received using the one or more RACH resources as indicated by the partition for SBFD operation.
Aspect 27: The method of any of Aspects 25-26, wherein receiving the one or more repetitions indicates an SBFD capability of the UE.
Aspect 28: The method of Aspect 27, wherein: the partition for SBFD operation is a first partition; and the random access configuration includes a second partition that is associated with non-SBFD operation.
Aspect 29: The method of Aspect 28, wherein the first partition and the second partition are each associated with repetitions.
Aspect 30: The method of Aspect 28, wherein: the UE is a reduced capability (RedCap) type of UE; the first partition is for SBFD operation of the RedCap device type of UE; and receiving the one or more repetitions indicates the RedCap device type of UE.
Aspect 31: The method of Aspect 30, wherein the random access configuration includes a third partition that is associated with SBFD operation of a non-RedCap device type of UE.
Aspect 32: The method of Aspect 31, wherein: the second partition is associated with non-SBFD operation of the RedCap device type of UE; and the random access configuration includes a fourth partition that is associated with non-SBFD operation of the non-RedCap device type of UE.
Aspect 33: The method of any of Aspects 28-29, wherein: the UE is not a reduced capability (RedCap) type of UE; the first partition is for SBFD operation of a non-RedCap device type of UE; and receiving the one or more repetitions indicates the non-RedCap device type of UE.
Aspect 34: The method of Aspect 33, wherein the random access configuration includes a third partition that is associated with SBFD operation of a RedCap device type of UE.
Aspect 35: The method of Aspect 34, wherein: the second partition is associated with non-SBFD operation of the non-RedCap device type of UE; and the random access configuration includes a fourth partition that is associated with non-SBFD operation of the RedCap device type of UE.
Aspect 36: The method of any of Aspects 28-35, wherein the random access configuration indicates a first feature combination preamble list that indicates the first partition and a second feature combination preamble list that indicates the second partition.
Aspect 37: The method of Aspect 36, wherein the random access configuration is included in a RACH-ConfigCommon information element.
Aspect 38: The method of any of Aspects 27-37, wherein the SBFD capability of the UE is associated with the UE supporting RACH resources in uplink time intervals and SBFD time intervals.
Aspect 39: The method of any of Aspects 25-38, wherein the random access configuration includes a first random access configuration that is associated with non-SBFD operation and a second random access configuration that is associated with the SBFD operation, and wherein the partition for SBFD operation is indicated by the second random access configuration.
Aspect 40: The method of Aspect 39, wherein the second random access configuration is included in an SBFD RACH-ConfigCommon information element.
Aspect 41: The method of Aspect 39, wherein the second random access configuration is included in a RACH-ConfigCommon information element with SBFD enabled.
Aspect 42: The method of Aspect 39, wherein the second random access configuration is included in a RACH-ConfigCommon information element.
Aspect 43: The method of any of Aspects 25-42, wherein receiving the one or more repetitions comprises: receiving a first repetition, of the multiple repetitions, via a first RACH occasion within an uplink subband of an SBFD time interval, wherein the partition for SBFD operation indicates the first RACH occasion.
Aspect 44: The method of Aspect 43, wherein receiving the one or more repetitions comprises: receiving a second repetition, of the multiple repetitions, via a second RACH occasion within an uplink time interval, wherein the partition for SBFD operation indicates the second RACH occasion.
Aspect 45: The method of any of Aspects 25-44, wherein; the partition for SBFD operation is associated with a quantity of the multiple repetitions; the partition for SBFD operation indicates a set of RACH occasions and a preamble index range; and at least one RACH occasion, of the set of RACH occasions, occurs during an SBFD time interval.
Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-45.
Aspect 47: An apparatus for wireless communication at a device, the apparatus comprising one or more memories and one or more processors coupled to the one or more memories, the one or more processors configured to cause the device to perform the method of one or more of Aspects 1-45.
Aspect 48: An apparatus for wireless communication, the apparatus comprising at least one means for performing the method of one or more of Aspects 1-45.
Aspect 49: A non-transitory computer-readable medium storing code for wireless communication, the code comprising instructions executable by one or more processors to perform the method of one or more of Aspects 1-45.
Aspect 50: A non-transitory computer-readable medium storing a set of instructions for wireless communication, the set of instructions comprising one or more instructions that, when executed by one or more processors of a device, cause the device to perform the method of one or more of Aspects 1-45.
Aspect 51: A device for wireless communication, the device comprising a processing system that includes one or more processors and one or more memories coupled with the one or more processors, the processing system configured to cause the device to perform the method of one or more of Aspects 1-45.
Aspect 52: An apparatus for wireless communication at a device, the apparatus comprising one or more memories and one or more processors coupled to the one or more memories, the one or more processors individually or collectively configured to cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus configured for wireless communication, comprising:
one or more memories comprising processor-executable instructions; and
one or more processors configured to execute the processor-executable instructions and cause the apparatus to:
receive, from a network node, a random access configuration including at least one partition of random access channel (RACH) resources,
wherein the at least one partition includes a partition for subband full duplex (SBFD) operation, and
wherein the partition for SBFD operation is associated with repetitions; and
transmit, in accordance with the random access configuration, one or more repetitions of multiple repetitions of a random access message using one or more RACH resources as indicated by the partition for SBFD operation.

2. The apparatus of claim 1, wherein the one or more repetitions are transmitted using the one or more RACH resources as indicated by the partition for SBFD operation.

3. The apparatus of claim 2, wherein transmitting the one or more repetitions indicates an SBFD capability of the apparatus.

4. The apparatus of claim 2, wherein the one or more processors are configured to cause the apparatus to:
select, based on the apparatus supporting the SBFD operation, the one or more RACH resources indicated by the partition for SBFD operation.

5. The apparatus of claim 1, wherein:
the partition for SBFD operation is a first partition; and
the random access configuration includes a second partition that is associated with non-SBFD operation.

6. The apparatus of claim 5, wherein the first partition and the second partition are each associated with repetitions.

7. The apparatus of claim 6, wherein the one or more processors are configured to cause the apparatus to:
select, based on the apparatus supporting the SBFD operation, the first partition for the multiple repetitions.

8. The apparatus of claim 5, wherein:
the apparatus is a reduced capability (RedCap) type of apparatus;
the first partition is for SBFD operation of the RedCap device type of apparatus; and
transmitting the one or more repetitions indicates the RedCap device type of apparatus.

9. The apparatus of claim 8, wherein the random access configuration includes a third partition that is associated with SBFD operation of a non-RedCap device type of apparatus.

10. The apparatus of claim 9, wherein:
the second partition is associated with non-SBFD operation of the RedCap device type of apparatus; and
the random access configuration includes a fourth partition that is associated with non-SBFD operation of the non-RedCap device type of apparatus.

11. The apparatus of claim 5, wherein:
the apparatus is not a reduced capability (RedCap) type of apparatus;
the first partition is for SBFD operation of a non-RedCap device type of apparatus; and
transmitting the one or more repetitions indicates the non-RedCap device type of apparatus.

12. The apparatus of claim 11, wherein the random access configuration includes a third partition that is associated with SBFD operation of a RedCap device type of apparatus.

13. The apparatus of claim 12, wherein:
the second partition is associated with non-SBFD operation of the non-RedCap device type of apparatus; and
the random access configuration includes a fourth partition that is associated with non-SBFD operation of the RedCap device type of apparatus.

14. The apparatus of claim 5, wherein the random access configuration indicates a first feature combination preamble list that indicates the first partition and a second feature combination preamble list that indicates the second partition.

15. The apparatus of claim 1, wherein the random access configuration includes a first random access configuration that is associated with non-SBFD operation and a second random access configuration that is associated with the SBFD operation, and wherein the partition for SBFD operation is indicated by the second random access configuration.

16. The apparatus of claim 1, wherein the one or more processors, to cause the apparatus to transmit the one or more repetitions, are configured to cause the apparatus to:
transmit a first repetition, of the multiple repetitions, via a first RACH occasion within an uplink subband of an SBFD time interval, wherein the partition for SBFD operation indicates the first RACH occasion.

17. The apparatus of claim 16, wherein the one or more processors, to cause the apparatus to transmit the one or more repetitions, are configured to cause the apparatus to:
transmit a second repetition, of the multiple repetitions, via a second RACH occasion within an uplink time interval, wherein the partition for SBFD operation indicates the second RACH occasion.

18. The apparatus of claim 1, wherein;
the partition for SBFD operation is associated with a quantity of the multiple repetitions;
the partition for SBFD operation indicates a set of RACH occasions and a preamble index range; and
at least one RACH occasion, of the set of RACH occasions, occurs during an SBFD time interval.

19. The apparatus of claim 1, wherein:
the partition for SBFD operation includes a first partition for SBFD operation of a reduced capability (RedCap) type of apparatus, and a second partition for SBFD operation of a non-RedCap type of apparatus;
the apparatus is a non-RedCap type of apparatus; and
the one or more RACH resources are indicated by the second partition.

20. A method of wireless communication performed by a user equipment (UE), comprising:
receiving, from a network node, a random access configuration including at least one partition of random access channel (RACH) resources,
wherein the at least one partition includes a partition for subband full duplex (SBFD) operation, and
wherein the partition for SBFD operation is associated with repetitions; and
transmitting, in accordance with the random access configuration, one or more repetitions of multiple repetitions of a random access message using one or more RACH resources as indicated by the partition for SBFD operation.
